(19) United States
(12) Patent Application Publication
(10) Pub. No.: US 2026/0186282 A1
(43) Pub. Date: Jul. 2, 2026

(54) GUIDED MUNITION AND OPTICAL ASSEMBLY WITH AN ANNULAR FOLDED OPTIC AND BEAMSPLITTER

(71) Applicant: BAE Systems Information and Electronic Systems Integration Inc., Nashua, NH (US)

(72) Inventor: Scott J. Adams, Groton, MA (US)

(73) Assignee: BAE Systems Information and Electronic Systems Integration Inc., Nashua, NH (US)

(21) Appl. No.: 18/826,891

(22) Filed: Sep. 6, 2024

(51) Int. Cl. G02B 17/08; F41G 7/22; F41G 7/26; G02B 27/00; G02B 27/12; G02B 27/16; H04N 23/13; H04N 23/23

(52) U.S. Cl. CPC G02B 17/0808; F41G 7/2293; F41G 7/26; G02B 27/0037; G02B 27/123; G02B 27/16; H04N 23/13; H04N 23/23

(57) ABSTRACT

A guided munition and associated method, which may be implemented by a computer program product, is provided. The guided munition may have an annular folded optic (AFO) that has a frontal surface and a rear surface. There may be a first imager in optical communication with the frontal surface and a second imager in optical communication with rear surface. A beamsplitter may be coupled to one of the frontal surface and the rear surface. The beamsplitter splits electromagnetic radiation moving through the body of the AFO into a first portion directed toward the first imager and a second portion directed toward the second imager. This allows for the addition of both a second and a third image sensor to an existing primary sensor like a radar with a phased array antenna.

### RELATED APPLICATIONS

Initially, it is noted that the present disclosure is related to the below listed U.S. Patent applications (“the Incorporated Applications”), filed on equal date herewith, the entirety of each of which is incorporated herein as if fully rewritten. The Incorporated Applications are:
1. U.S. patent application Ser. No. ______, entitled “GUIDED MUNITION AND OPTICAL ASSEMBLY WITH AN ANNULAR FOLDED OPTIC HAVING A SLOT EXTENDING THERETHROUGH”, having the Attorney Docket Number: 23-BAE-0503; and
2. U.S. patent application Ser. No. ______, entitled “GUIDED MUNITION AND OPTICAL ASSEMBLY WITH AN ANNULAR FOLDED OPTIC HAVING AN INTERFACE WITH A DEPLOYABLE SEGMENT”, having the Attorney Docket Number: 23-BAE-0498.
   Since the present disclosure is related to the Incorporated Applications, some similar structural nomenclature is used herein when referencing some portions of the present disclosure relative to the Incorporated Applications. However, there may be some instances where structural nomenclature differs between similar elements and there may be other instances where nomenclature is similar between distinct elements relative to the present disclosure and the Incorporated Applications. Further, there may be instances in this disclosure that utilize similar reference numerals when referencing some portions or components of the present disclosure and its associated method(s) as in the Incorporated Applications. However, there may also be instances where (i) different reference numerals are utilized herein to refer to similar components as in the Incorporated Applications and/or (ii) similar reference numerals are utilized herein to refer to different components from the Incorporated Applications.

### TECHNICAL FIELD

The present disclosure relates generally to optical assemblies, namely, optical assemblies with an annular folded optic.

### BACKGROUND ART

In military operations, modern projectiles or ballistic devices being launched from various platforms, including mobile and stationary vehicles, may be equipped with at least one guidance kit for guiding these projectiles to a desired target or point of interest.

One exemplary munition system is the Applicant's (BAE Systems) munition system which uses one or more lenses. BAE Systems'APKWS® is a laser-guided rocket system designed to provide precision strike capabilities for military aircraft. It includes a guidance kit having one or more lenses that can be attached to standard unguided 2.75-inch (70 mm) rockets or 4-inch rockets, transforming them into highly accurate, laser-guided munitions. The APKWS guidance kit allows for improved targeting and reduced collateral damage compared to unguided rockets.

APKWS is designed to be a cost-effective solution for enhancing the precision of existing rocket systems, providing an affordable option for guided munitions. It's suitable for a range of platforms, including helicopters, fixed-wing aircraft, and unmanned aerial systems (UAS) as well as ground and maritime deployment. The system is often used for close air support and other missions where precision is crucial while minimizing the risk of collateral.

Some exemplary munitions systems utilize optical assemblies to assist in their targeting capabilities. However, these optical assemblies are not without fault. For example, guided munitions such as APKWS require active target illumination by a laser. This places the laser designator at risk of harm for detection by countermeasures with sensors designed to detect designating lasers.

### SUMMARY OF THE INVENTION

Having thus provided a brief background on some guided munition systems that utilize lenses or other optical components, it has been recognized that what is needed is an improvement to guided munitions. To reduce the risk of harm to laser designators, a significant effort has been underway to replace or supplement active target seekers with passive technology-based sensors. Passive seeker sensors output no electromagnetic energy nor require external designators to output electromagnetic energy. However, adding new target sensing technology to existing missile seekers proves challenging due to requirements to maintain current capability while adding new ones. The present disclosure furthers the current state-of-the art by using unique configurations of annular folded optics.

In exemplary embodiment, it is beneficial for seekers that have more than one sensor on board. For instance, currently, APKWS only supports targeting a single wavelength laser return. The future is in having multiple sensors like long-wave infrared (LWIR), mid-wave infrared (MWIR), short-wave infrared (SWIR), active radar, passive radar, etc. modalities. Current limitations on seeker volume makes adding a second, third or fourth modality very difficult. The present disclosure addresses these and other issues. In some exemplary embodiments, the present disclosure provides guided munition having an imaging device including an annular folded optic, amongst other components, such as an additional electromagnetic sensor, to expand modalities or instantiations. In one example, the seeker is improved by adding an additional imaging device. While some embodiments may provide a small reduction in performance compared to a conventional imaging device with a standard lens, the benefits of adding an additional imaging device where there was not one outweighs those slight reductions in performance.

In one aspect, an exemplary embodiment of the present disclosure may provide a guided munition comprising: a munition body powered by a rocket motor or engine to propel the munition body through a medium in response to being fired or launched; an annular folded optic (AFO) on the guided munition, wherein the AFO has a frontal surface and a rear surface, and a body of the AFO extending between the frontal surface and the rear surface; a first imager or image sensor (e.g., a camera) in optical communication with the frontal surface; a second imager or image sensor in optical communication with rear surface, wherein these two concentric reflective surfaces are formed as two sides of a single refractive solid lens, or two reflective surfaces of two facing mirrors comprising multiple concentric reflective zones; and a beamsplitter optically coupled, directly or indirectly, to one of the frontal surface and the rear surface, wherein the beamsplitter splits electromagnetic radiation moving through the body of the AFO into a first portion directed toward the first imager and a second portion directed toward the second imager. This exemplary embodiment or another exemplary embodiment may further provide that a portion of the frontal surface is concave, wherein the beamsplitter is coupled to the concave portion of the frontal surface. However, in other embodiments the frontal surface can be flat or convex. This exemplary embodiment or another exemplary embodiment may further include a central axis extending centrally through the body of the AFO from the frontal surface to the rear surface; wherein the beamsplitter is positioned such that the central axis intersects the beamsplitter. This exemplary embodiment or another exemplary embodiment may provide that the first imager is positioned such that the central axis intersects the first imager. This exemplary embodiment or another exemplary embodiment may further provide that the second imager is positioned such that the central axis intersects the second imager. This exemplary embodiment or another exemplary embodiment may further include a modular first portion defining a front end of the guided munition; a modular second portion located rearward of the modular first portion, wherein the modular second portion selectively connects with the modular first portion; a modular third portion located rearward of the modular second portion, wherein the modular third portion selectively connects with the modular second portion, wherein the modular third portion is a motor or engine to propel the guided munition through a medium; wherein AFO is position forward of the modular third portion. The AFO may be carried by the modular first portion or the modular second portion. This exemplary embodiment or another exemplary embodiment may further include a guidance kit located within one of the modular first portion and the modular second portion, wherein the AFO is in operative communication with the guidance kit such that electromagnetic radiation that has passed through the AFO is detected by at least one of the first imager and the second imager that generates at least one signal that is provided to the guidance kit and the signal is utilized to guide the guided munition toward a target. It is to be understood that before providing the signal to the guidance kit, there are protocols or algorithms to detect the target, identify the target, and then provide target pointing/vector data to the guidance kit.

In another aspect, an exemplary embodiment of the present disclosure may simply be an optical assembly comprising: an AFO that has a frontal surface and a rear surface, and a body of the AFO extending between the frontal surface and the rear surface; a first imager in optical communication with the frontal surface; and a second imager in optical communication with rear surface; and a beamsplitter coupled to one of the frontal surface and the rear surface, wherein the beamsplitter splits electromagnetic radiation moving through the body of the AFO into a first portion that is directed toward the first imager and a second portion that is directed toward the second imager.

In yet another aspect, an exemplary embodiment of the present disclosure may provide a computer program product including one or more non-transitory machine-readable mediums encoded with instructions that when executed by one or more processors cause a process to detect electromagnetic radiation moving through an AFO to image a scene, wherein at least one image of the scene is to be provided to a target detection protocol or guidance protocol, the instructions comprising: receive, at a first imager, a first portion of electromagnetic radiation that has moved through the AFO and has been split at a beamsplitter coupled to one of a frontal surface and a rear surface of the AFO; generate a first image with the first imager; receive, at a second imager, a second portion of electromagnetic radiation that has moved through the AFO and has been split at the beamsplitter; generate a second image with the second imager; and provide at least one of the first image and the second image to the target detection protocol or guidance protocol. This exemplary embodiment or another exemplary embodiment may further provide that the instructions further comprise: receive, at a perimeter inlet aperture of the AFO, electromagnetic radiation; and reflect, via at least one of the frontal surface and the rear surface, the received electromagnetic radiation through the AFO toward a central axis extending centrally through the body of the AFO from the frontal surface to the rear surface, wherein the beamsplitter is positioned such that the central axis intersects the beamsplitter. This exemplary embodiment or another exemplary embodiment may further provide that the instructions further comprise: receive, at the first imager, the first portion of electromagnetic radiation that has moved through a concave portion of the frontal surface. This exemplary embodiment or another exemplary embodiment may further provide that the instructions further comprise: receive, at the second imager, electromagnetic radiation that has moved through a convex portion of the rear surface after having been split by the beamsplitter. This exemplary embodiment or another exemplary embodiment may further provide that the instructions further comprise: receive, at one of the first imager and the second imager, electromagnetic radiation that has moved through a diffractive optical element (DOE) or a metalens with a diffractive metasurface after having been split by the beamsplitter to provide chromatic aberration correction.

In another aspect, an exemplary embodiment of the present disclosure may provide a guided munition comprising: a munition body powered by a motor or engine to propel the munition body through a medium in response to being fired or launched; a warhead coupled to the munition body; and an AFO on the guided munition positioned forwardly of the warhead. This exemplary embodiment or another exemplary embodiment may further provide that the AFO comprises: a frontal surface and a rear surface, and a body of the AFO extending between the frontal surface and the rear surface; a thickness of the body of the AFO measured from the frontal surface to the rear surface; a central axis extending fore-to-aft centrally through the body of the AFO from the frontal surface to the rear surface; and a first slot extending entirely through the thickness of the body of the AFO. This exemplary embodiment or another exemplary embodiment may further provide that the first slot has a proximal end and a distal end defining a length of the first slot, wherein the length of the first slot is coaxial to a first radius of the AFO originating at the central axis. This exemplary embodiment or another exemplary embodiment may further provide that the proximal end of the first slot is radially distal from the central axis. This exemplary embodiment or another exemplary embodiment may further include at least one sensor positioned forwardly of the frontal surface of the AFO; and a signal transmission component connected to the at least one sensor, wherein the signal transmission components extends through the first slot to transmits a sensor signal to a receiving device that is positioned rearward of the rear surface of the AFO. This exemplary embodiment or another exemplary embodiment may further provide that the AFO further comprises: a second slot extending entirely through the thickness of the body of the AFO, wherein the second slot has a proximal end and a distal end defining a length of the second slot, wherein the length of the second slot is coaxial to a second radius of the AFO originating at the central axis, wherein the second radius is approximately 90 degrees from the first radius. This exemplary embodiment or another exemplary embodiment may further provide that the AFO further comprises: a third slot extending entirely through the thickness of the body of the AFO, wherein the third slot has a proximal end and a distal end defining a length of the third slot, wherein the length of the third slot is coaxial to a third radius of the AFO originating at the central axis, wherein the third radius is approximately 90 degrees from the second radius, and the third radius is approximately 180 degrees from the first radius. This exemplary embodiment or another exemplary embodiment may further provide that the AFO further comprises: a fourth slot extending entirely through the thickness of the body of the AFO, wherein the fourth slot has a proximal end and a distal end defining a length of the fourth slot, wherein the length of the fourth slot is coaxial to a fourth radius of the AFO originating at the central axis, wherein the fourth radius is approximately 90 degrees from the first radius and the third radius, and the fourth radius is approximately 180 degrees from the second radius. This exemplary embodiment or another exemplary embodiment may further include at least one semiconductor positioned within the first slot. In another embodiment, the first slot is utilized to pass or extend electrical components therethrough. For example, when the sensor in front of the AFO is an antenna or an imaging device, the power cables needed for this forward sensor can extend through the slot. Alternatively, mechanical flexures or posts can extend through at least one of the slots to support the antenna or the second imaging device.

In another aspect, an exemplary embodiment of the present disclosure may simply be an optical assembly comprising: an AFO having a frontal surface and a rear surface, and a body of the AFO extending between the frontal surface and the rear surface; a thickness of the body of the AFO measured from the frontal surface to the rear surface; a central axis extending fore-to-aft centrally through the body of the AFO from the frontal surface to the rear surface; and a first slot extending entirely through the thickness of the body of the AFO.

In yet another aspect, an embodiment of the present disclosure may provide a computer program product including one or more non-transitory machine-readable mediums encoded with instructions that when executed by one or more processors cause a process to detect electromagnetic radiation moving through an AFO to image a scene, wherein at least one image of the scene is to be provided to a target detection protocol or guidance protocol, the instructions comprising: receive, at an imager, electromagnetic radiation that has moved through the AFO, wherein the AFO is positioned forwardly from a warhead on the guided munition; generate an image with the imager; and provide the image to one of (i) a target detection protocol that detects a target in the image or (ii) a guidance protocol that guides the guided munition toward the target in the image. This exemplary embodiment or another exemplary embodiment may further provide that the instructions further comprise: sense a signal with a sensor positioned forwardly of the AFO; and transmit the signal through a signal transmission component that extends through a first slot formed through a thickness of the body of the AFO.

In yet another aspect, an embodiment of the present disclosure may provide a guided munition comprising: a munition body powered by a motor or engine to propel the munition body through a medium in response to being fired or launched; a first wing connected to the munition body; and an AFO, wherein at least a first portion of the AFO is, at least partially, in the wing. This exemplary embodiment or another exemplary embodiment may further include a warhead coupled to the munition body, wherein the AFO is positioned rearward of the warhead. This exemplary embodiment or another exemplary embodiment may further include a first segment of the first portion of the AFO; a second segment of the first portion of the AFO, wherein the first segment is radially distal from the second segment relative to a central axis of the AFO; wherein the first segment and the second segment are moveable relative to each other between a collapsed position and a deployed position; and an optical interface between the first segment and the second segment when the first segment and the second segment are in the deployed position, wherein electromagnetic radiation received at an inlet on the first segment moves through the interface. This exemplary embodiment or another exemplary embodiment may further include a second deployable wing pivotably connected to the munition body; and a second portion of the AFO on the second deployable wing. This exemplary embodiment or another exemplary embodiment may further include a third deployable wing pivotably connected to the munition body; and a third portion of the AFO on the third deployable wing. This exemplary embodiment or another exemplary embodiment may further include a fourth deployable wing pivotably connected to the munition body; and a fourth portion of the AFO on the fourth deployable wing. This exemplary embodiment or another exemplary embodiment may further include a first segment of the first portion of the AFO and a second segment of the first portion of the AFO, wherein the first segment of the first portion is radially distal from the second segment of the first portion relative to a central axis of the AFO, wherein the first segment and the second segment of the first portion are moveable relative to each other between a collapsed position and a deployed position; a first interface between the first segment and the second segment of the first portion when the first segment and the second segment of the first portion are in the deployed position, wherein electromagnetic radiation received at a first inlet on the first segment of the first portion moves through the first interface; a first segment of the second portion of the AFO and a second segment of the second portion of the AFO, wherein the first segment of the second portion is radially distal from the second segment of the second portion relative to the central axis of the AFO, wherein the first segment and the second segment of the second portion are moveable relative to each other between a collapsed position and a deployed position; and a second interface between the first segment and the second segment of the second portion when the first segment and the second segment of the second portion are in the deployed position, wherein electromagnetic radiation received at a second inlet on the first segment of the second portion moves through the second interface. This exemplary embodiment or another exemplary embodiment may further include a first segment of the third portion of the AFO and a second segment of the third portion of the AFO, wherein the first segment of the third portion is radially distal from the second segment of the third portion relative to the central axis of the AFO, wherein the first segment and the second segment of the third portion are moveable relative to each other between a collapsed position and a deployed position; a third interface between the first segment and the second segment of the third portion when the first segment and the second segment of the third portion are in the deployed position, wherein electromagnetic radiation received at a third inlet on the first segment of the third portion moves through the third interface; a first segment of the fourth portion of the AFO and a second segment of the fourth portion of the AFO, wherein the first segment of the fourth portion is radially distal from the second segment of the fourth portion relative to the central axis of the AFO, wherein the first segment and the second segment of the fourth portion are moveable relative to each other between a collapsed position and a deployed position; and a fourth interface between the first segment and the second segment of the fourth portion when the first segment and the second segment of the fourth portion are in the deployed position, wherein electromagnetic radiation received at a fourth inlet on the first segment of the fourth portion moves through the fourth interface. In this embodiment, the wings with the respective portions of the AFO may be radially symmetric with another portion on a different wing. Other embodiments can include more inlets. For example, one embodiment can be an eight-wing configuration that would have eight inlets, one on each wing. This exemplary embodiment or another exemplary embodiment may further include a lens for a seeker such as a distributed aperture semi-active laser seeker located on the first deployable wing distally from the first portion of the AFO on the first deployable wing. When four wings are utilized, a bullet lens for a seeker can be located on each of the four wings. In one example, when eight wings are utilized, a bullet lens for the seeker can be on four of the eight wings.

In another aspect, an exemplary embodiment of the present disclosure may simply be an transversely segmented AFO comprising: a body defining a frontal surface and a rear surface of the AFO, wherein at least one of the frontal surface and the rear surface internally reflects electromagnetic radiation through the body; a central axis extending centrally through the body from the frontal surface to the rear surface; a first portion of the AFO comprising a first segment of the body and a second segment of the body that selectively interface at a first interface in response to at least one instruction to move the first segment and the second segment closer to each other; and an interface plane, wherein the interface lies along the interface plane and the interface plane intersects the central axis at a point, wherein the point at which the interface plane intersects the central axis is located outside the body of the AFO.

In yet another aspect, an exemplary embodiment of the present disclosure may provide computer program product including one or more non-transitory machine-readable mediums encoded with instructions that when executed by one or more processors cause a process to detect electromagnetic radiation moving through an annular folded optic (AFO) to image a scene, wherein at least one image of the scene is to be provided to a target detection protocol or guidance protocol, the instructions comprising: receive, at an imager, electromagnetic radiation that has moved through the AFO, wherein at least a portion of the AFO is positioned on a wing on the guided munition; generate an image with the imager; and provide the image to one of (i) a target detection protocol that detects a target in the image or (ii) a guidance protocol that guides the guided munition toward the target in the image. This exemplary embodiment or another exemplary embodiment may further provide that the instructions further comprise: move a first segment on a first portion of the AFO relative to a second segment on the first portion of the AFO, wherein the first segment moves between a collapsed position and a deployed position; and create an optical interface between the first segment and the second segment when the first segment is in the deployed position, wherein electromagnetic radiation received at an inlet on the first segment moves through the interface.

In yet another aspect, an exemplary embodiment of the present disclosure may provide a transversely segmented AFO comprising a first segment and a second segment that selectively interface in response to at least one instruction to move the first segment and the second segment together, wherein the first segment is positioned radially distal from the second segment relative to a central axis extending through the AFO from a frontal surface to a rear surface, wherein the interface lies along an interface plane and the interface plane intersects the central axis at an angle that is in a range from about 10° to about 80°.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is an operational diagrammatic cross section view of one exemplary annular folded optic in operative communication with a beamsplitter and two image sensors.

FIG. 1A is a flow chart depicting an exemplary method of operation of the exemplary annular folded optic from FIG. 1.

FIG. 2 is a diagrammatic perspective view of an exemplary device that can carry the various embodiments of an optical assembly having an annular folded optic.

FIG. 2A is a diagrammatic perspective view of an exemplary device having an exemplary annular folded optic located forward of a warhead.

FIG. 2B is a diagrammatic perspective view of an exemplary device having an exemplary annular folded optic located rearward of a warhead.

FIG. 3A is a front elevation view of another exemplary annular folded optic having one or more slots extending front-to-back through the annular folded optic.

FIG. 3B is a front elevation view of the annular folded optic depicted in FIG. 3A shown with electrical components disposed within the slots.

FIG. 3C is a front elevation view of the annular folded optic depicted in FIG. 3A shown with a sensor positioned in front of the annular folded optic.

FIG. 3D is a front elevation view of another exemplary annular folded optic having one or more wedge-shaped slots extending front-to-back through the annular folded optic.

FIG. 4A is a cross section view taken along line 4A-4A in FIG. 3C diagrammatically depicting the annular folded optic and the sensor.

FIG. 4B is a cross section view taken along line 4B-4B in FIG. 3C diagrammatically depicting the annular folded optic and the sensor.

FIG. 5 is a front elevation view of another embodiment of an exemplary annular folded optic having one or more larger cut-away regions extending front-to-back through the annular folded optic that results in four elongated portions of the annular folded optic.

FIG. 6 is a front elevation view of an exemplary platform or munition having the annular folded optic shown from FIG. 5.

FIG. 7A is a diagrammatic cross section view of the annular folded optic from FIG. 5 positioned within the platform and the wings on the platform in a stowed or collapsed position.

FIG. 7B is a diagrammatic cross section view taken along line 7B-7B in FIG. 6 depicting the annular folded optic from FIG. 5 when the wings of the platform are in the deployed position.

FIG. 8 is a diagrammatic cross section depicting an annular folded optic with the wings of the platform in the deployed position and an image sensor being positioned on a side of the annular folded optic that is opposite that which is shown in FIG. 7B.

FIG. 9 depicts a number of exemplary photographs obtained from some of the various annular folded optics detailed herein.

Similar numbers refer to similar parts throughout the drawings.

### DETAILED DESCRIPTION

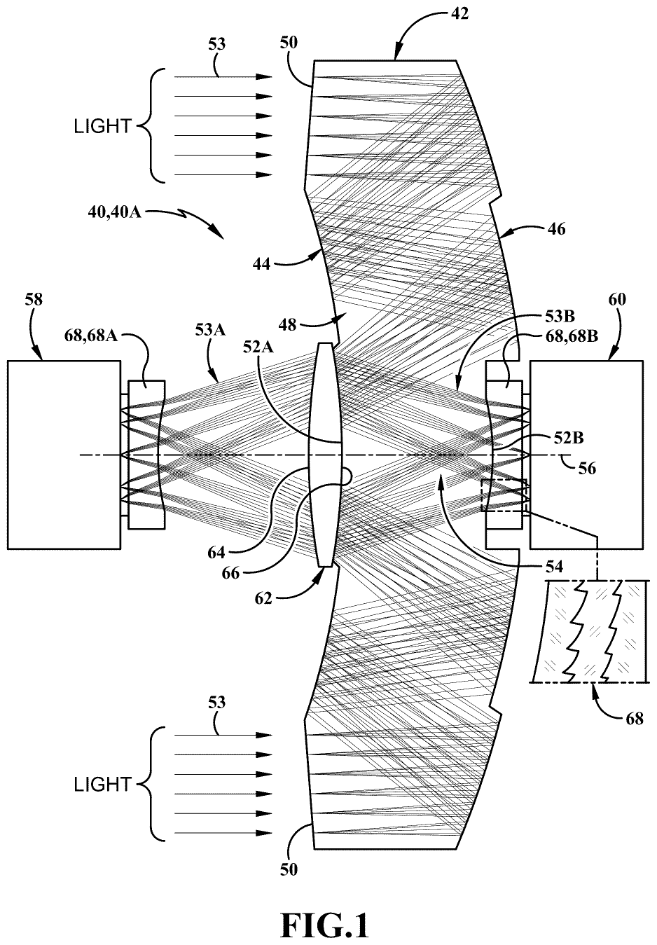

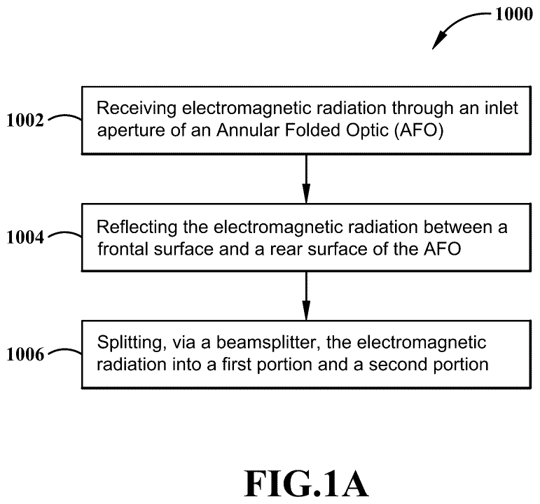

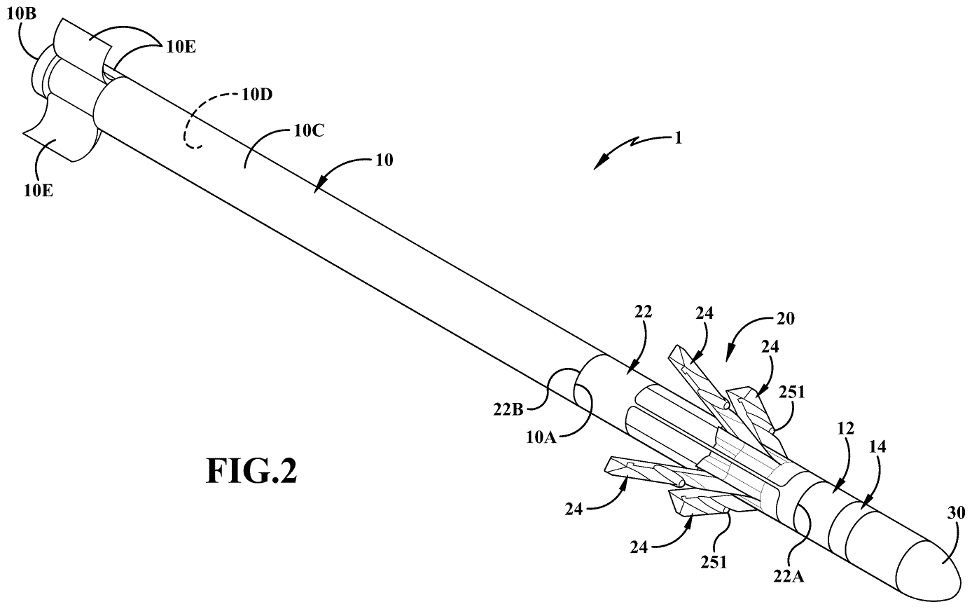

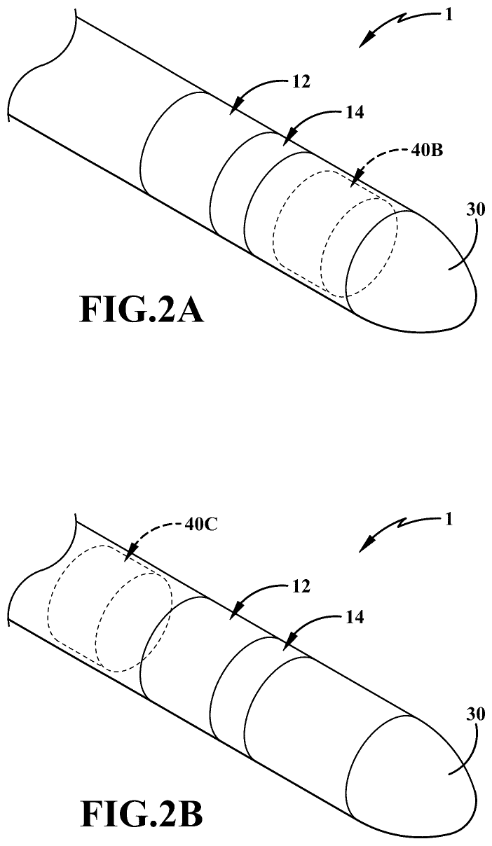

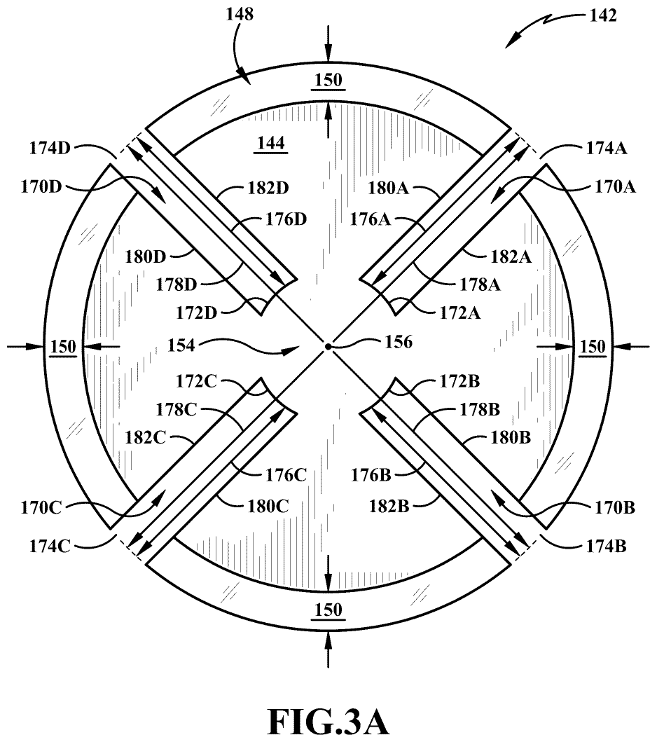

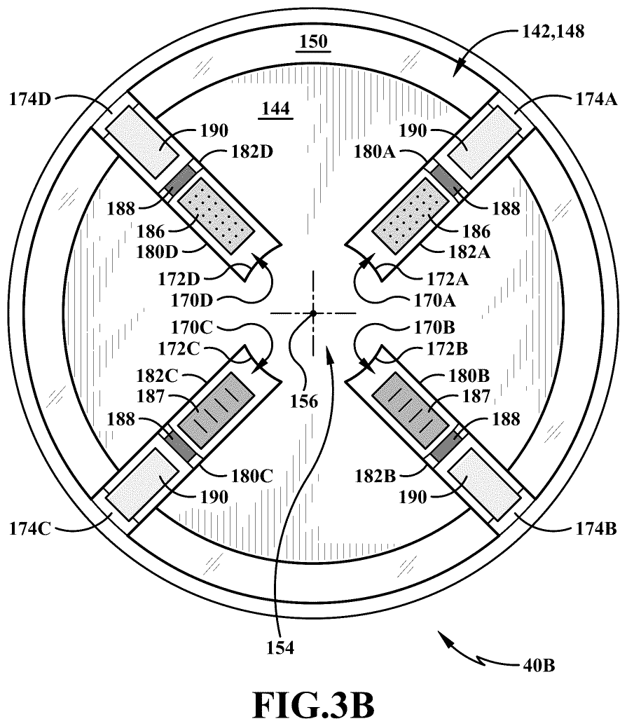

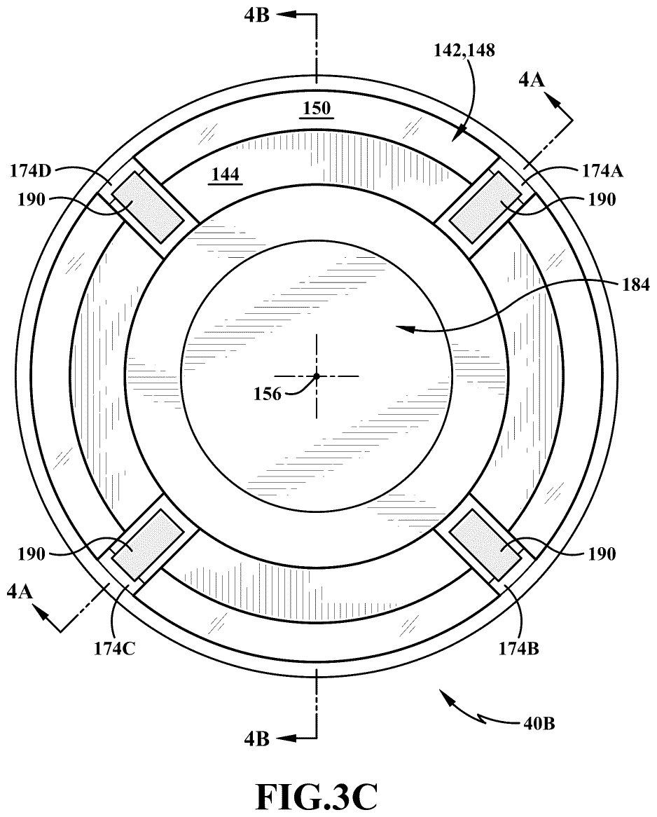

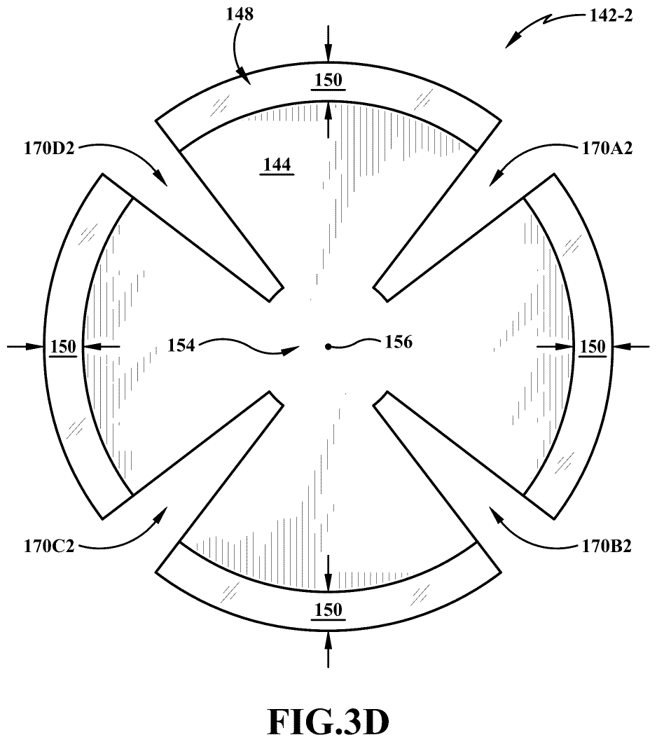

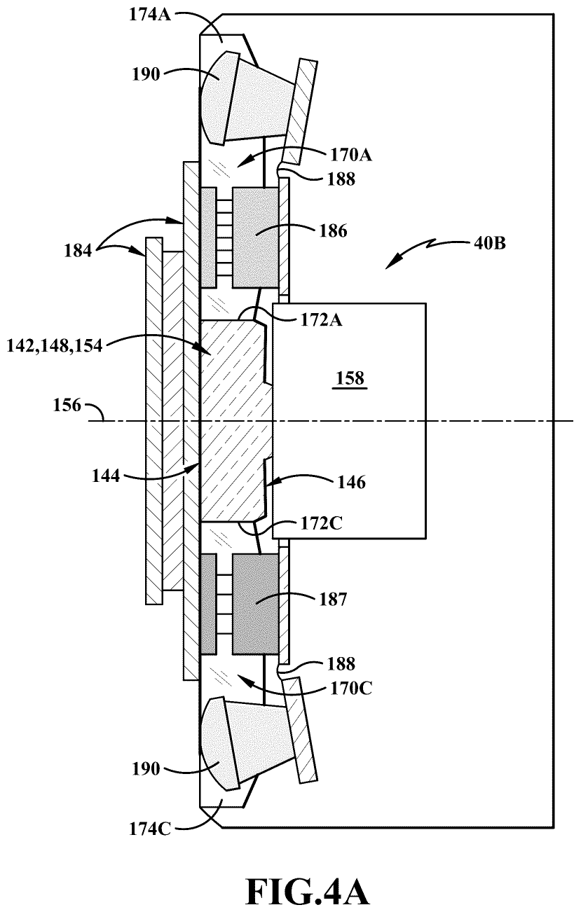

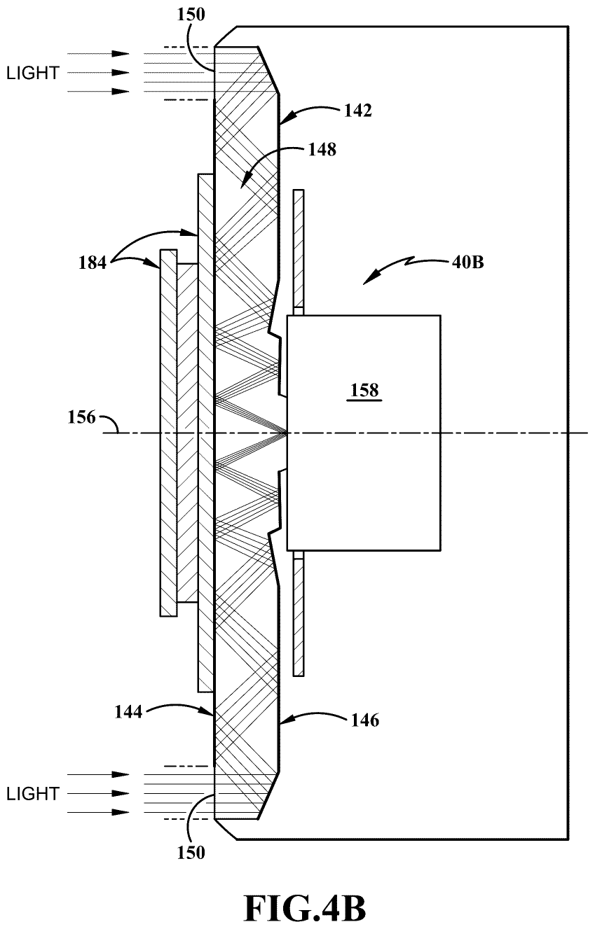

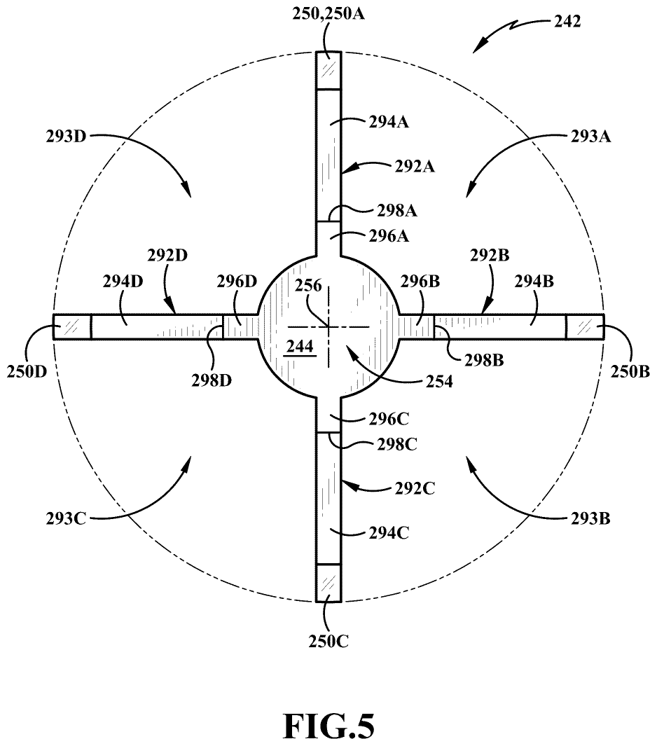

The present disclosure depict various embodiments of an optical assembly. The different embodiments of the optical assemblies detailed herein may be standalone optical systems or they may be incorporated into a broader system or assembly. Some of the embodiments of the optical assemblies utilize an annular folded optic (AFO). For example, the first embodiment of a first optical assembly 40A (cf., FIG. 1) may be installed in any type of optical system on any type of device or platform that carries the first optical assembly 40A. The second embodiment of a second optical assembly 40B (cf., FIG. 2A, FIGS. 3A-4B) may be carried by, mounted on, or installed upon a guided munition at a location that is forward of a warhead. The third embodiment of a third optical assembly 40C (cf., FIG. 2B, FIGS. 5-7) may be carried by, mounted on, or installed upon a guided munition at a location that is rearward of a warhead.

FIG. 1 depicts the first embodiment of the optical assembly 40 that can

be in any type of system (i.e., carried by, mounted on, or installed upon any type of suitable framework or supporting members) regardless of whether it is moveable (e.g., such as moveable device) or stationary (e.g., such as a fixed or tabletop imaging system). Namely, the first optical assembly 40A may include an AFO 42. An AFO is a type of optics design that leverages principles from conventional catadioptric devices but has configuration that achieves a more compact form factor. Catadioptric devices typically combine lenses and mirrors to form optical systems, and the AFO takes this concept further by incorporating multiple reflections of light between its reflective surfaces. Particularly, AFO 42 has a frontal surface 44 and a rear surface 46 with a body 48 extending therebetween. In another example, a body 48 may not be necessary and the reflective surfaces 44 and 46 may be formed by two opposing mirrors to define an AFO.

In this embodiment, the AFO 42 achieves a reduced-size lens by incorporating more than two reflections of light between its reflective surfaces (e.g. within the body 48 between its frontal surface 44 and its rear surface 46). This is accomplished by crafting the surfaces to have multiple, substantially annular and concentric reflective zones. These zones are designed for directionality, and incident light rays sequentially illuminate these zones, undergoing multiple reflections in the process. The compactness of the AFO 42 arises from its use of reflective surfaces on frontal surface 44 and rear surface 46, allowing for a reduction in the physical size of the lens compared to traditional designs. This can be advantageous in applications where space constraints are a concern. The reflective zones on the frontal surface 44 and rear surface 46 are arranged in concentric circles or rings. These annular zones guide the light in a way that facilitates multiple reflections. The design of these zones contributes to the optical properties of the AFO 42, allowing for a compact lens while maintaining the desired optical performance.

The AFO 42 employs one or more apertures strategically positioned that control the entry and exit of light, defining the optical path within each AFO. There is typically an inlet aperture 50 positioned around at least a portion of an outer periphery of one of the reflective surfaces and an outlet aperture 52A, 52B existing proximate or near a central region 54 of the AFO 42.

Some exemplary AFOs may have a plurality of reflections inside the body 48. For example, one exemplary AFO 42 may have eight reflections within the body 48 and another exemplary AFO 42 may have four reflections within the body. In some versions of the AFO 42, the frontal surface 44 may be flat and intersect a central axis 56 of the AFO. In other versions of the AFO, the frontal surface 44 may be facet cut with angled sections to create powered reflections of the light (e.g., to focus the light) moving through the body 48.

An exemplary 8-fold AFO 42 may be fabricated from a single piece of Calcium Fluoride and may have a 38 mm effective focal length, 6.7° field of view, 60 mm effective aperture diameter, and 5 mm total thickness. This exemplary design allows for reduced bulk and weight compared with large camera systems and improved resolution and light collection compared with miniature camera systems. An exemplary 4-fold AFO is similar in concept but has a different configuration. The 4-fold design may have an effective focal length (EFL) of 19 mm with an effective aperture diameter of 28 mm and a 17° field of view. The design of the 4-fold AFO is based on the same principles as the 8-fold AFO, but it is optimized for a different set of specifications.

Although the Calcium Fluoride material referenced above can be utilized to fabricate the body 48 of AFO 42, other materials can be used as well. Regardless of the material utilized to form the body of the AFO 42, that material forming the body of the AFO 42 should be transparent in the waveband of interest. The frontal and rear surfaces 44, 46 of the AFO 42 may be reflectively coated to cause the light moving the through the body to reflect internally within the AFO. The AFO 42 is uncoated around the perimeter edge of the AFO 42 to permit light to enter the body at the inlet aperture 50 where it is to be reflected from the outer perimeter toward the center that is coaxially along the central axis 56 of the AFO 42. Two image sensors or imagers 58, 60 are located adjacent to the center and in this embodiment intersects with central axis 56 such that the AFO 42 focus light entering the inlet aperture 50 around to the perimeter edge toward the imager sensors 58, 60 near the center of the AFO.

FIG. 1 depicts that the exemplary AFO 42 may have two outlet apertures 52A, 52B inasmuch as the optical assembly 40A may include a first imager 58 at least in optical communication with the frontal surface 44 and a second imager 60 at least in optical communication with rear surface 46. In another exemplary embodiment, both imagers 58, 60 could be in optical communication with both surfaces 44, 46. Optical assembly 40A includes a beamsplitter 62 coupled to either one of the frontal surface 44 and the rear surface 46. In the shown example, the beamsplitter 62 is on the frontal surface 44 of the AFO 42 at the first outlet aperture 52A. However, it is to be understood that the beamsplitter 62 could be placed on the rear surface 46 of the AFO 42 at the second outlet aperture 52B. Beamsplitter 62 may have a first surface 64 and a second surface 66.

The beamsplitter 62 splits electromagnetic radiation, such as light 53,

moving through the body 48 of the AFO 42 into a first portion 53A that is directed toward the first imager 58 and a second portion 53B that is directed toward the second imager 60. In this example, a portion of the frontal surface 44 is concave and the beamsplitter 62 is physically or optically coupled to the concave portion of the frontal surface 44 at or near the first outlet aperture 52A. Thus, second surface 66 of beamsplitter 62 may be either flat or convex. The beamsplitter 62 may be positioned such that the central axis 56 intersects the beamsplitter 62, wherein the central axis 62 extends centrally through the body 48 of the AFO 42 from the frontal surface 44 to the rear surface 46. The first imager 58 may be positioned such that the central axis 56 intersects the first imager 58, however other locations could be possible but may require various waveguides that direct the first portion 53A of light from the beamsplitter 62 to the first imager 58. Similarly, the second imager 60 may be positioned such that the central axis intersects 56 the second imager 60, however other locations could be possible but may require various waveguides that direct the second portion 53B of light from the beamsplitter 62 to the second imager 60. Thus, the first imager 58 may be in optical communication with the AFO 42 and be positioned forward of the frontal surface 44 and the second imager 60 may be in optical communication with the AFO 42 and be positioned rearward of the rear surface 46.

In one embodiment, the beamsplitter 62 may be a dichroic beamsplitter. A dichroic beamsplitter is an optical device that splits a beam of light into a transmitted and a reflected beam. It can also be used to split light into its constituent colors or frequency bands. In one specific example, the beamsplitter 62 has a first surface and a second surface, wherein the second surface has a curvature that matches the curvature of the frontal surface 44 of the AFO 42 and located proximate a mid-section of the frontal surface. The function of a dichroic beamsplitter is to split a beam of light 53 moving through the body 48 of the AFO 42 into at least two beams (e.g., the first portion 53A and the second portion 53B). One portion of the beam is transmitted through the beamsplitter 62 and the other portion is reflected. Some embodiments may also separate a polarized incident beam into multiple pairs of orthogonally polarized beams. In the exemplary case of a dichroic beamsplitter, it can split light into its constituent colors or frequency bands. In one exemplary embodiment, the formation of the beamsplitter involves the use of materials like glass or plastic, and processes such as low-temperature vacuum depositing for the application of coatings. The thickness of the coating is controlled so that part of the light is transmitted, and the remainder is reflected.

From an input beam of light 53 that enters the AFO at the perimeter inlet aperture 50 and is reflected multiple times by the frontal surface 44 and the rear surface 46 of the AFO 42, the output beam exits from the beamsplitter 62 with a separation angle that is determined during the design of the beamsplitter 62. The separation angle of a dichroic beamsplitter 62 refers to the angle between the incident light and the reflected light. If the dichroic beamsplitter is placed at an orientation of 45 degrees to the incident light, the reflected light will make an angle of 90 degrees. This angle of incidence may be 45°, leading to a 90° deflection of one of the output beams, as is often convenient. However, one can design such beamsplitters for other deflection angles to meet the application specific needs of the beamsplitter.

For a dichroic beamsplitter 62, the ratio of reflection to transmission will vary as a function of the wavelength of the incident light. This ratio is determined by the thickness of the optical coating. While an exemplary 50:50 ratio (i.e., half of the light is reflected as the second portion 53B, and half is transmitted through as the first portion 53A) is most common, other applications may need different ratios such as 30:70 or 40:60. Dichroic materials can change this ratio based on the material used.

The beamsplitter 62 can be optically coupled to the AFO 42 in a number

of different manners depending on the application specific needs of the optical assembly 40A. For example, optical cement may be used to physically attach the beamsplitter 62 to one of the surfaces, such as the frontal surface 44 of the AFO 42. Another method is to use mechanical mounts designed for holding optical components. These mounts can provide adjustable alignment features, which can be advantageous for fine-tuning the optical system. In other scenarios, the beamsplitter 62 can be designed as an integral part of the surface of the AFO 42. In other examples, some dichroic beamsplitters are designed to be compatible with cage systems, which are modular systems for building optical setups. These systems allow for easy insertion and removal of optical components, including beamsplitters. In some applications, different beamsplitters might be used for different wavelengths. In such cases, a filter wheel or slider equipped with different splitters can be used.

In one embodiment, one of the surfaces of either the beamsplitter 62 or the AFO 42 may have an Indium Tin Oxide (ITO) coating. An ITO coating is a highly conductive material that can be applied as a coating to optical components, including lenses like the AFO 42. In some embodiments, this ITO coating is not only highly conductive but also completely transparent. The ITO coating may be applied using low-temperature vacuum depositing, and it can be applied to various substrates including glass, plastic (acrylic, polycarbonate, and polyester), and more, any of which could be utilized to form the body 48 of the AFO 42. This makes it an exemplary choice for applications that require both conductivity and optical transparency. ITO coatings may have anti-reflective (AR) coatings. An AR coating is a type of optical coating applied to the surface of lenses and other optical elements to reduce reflection. This may improve the efficiency of optical assembly 40A (or other optical assemblies detailed herein) as less light is lost due to reflection. The ITO coating could enhance the performance of the AFO 42 by reducing unwanted reflections and maintaining high optical transparency. Alternative to the ITO coating, there are other materials that function in a similar way to achieve a similar result.

Some embodiments of optical assembly 40A (or other embodiments of an optical assembly detailed herein) may further include a diffractive element or diffractive optical element (DOE) 68 located along the optical transmission path between the beamsplitter 62 and one of the imagers. For example, there may be a first DOE 68A between the beamsplitter 62 and one of the imagers, such as the second imager 60. The purpose of a DOE, or a Meta-lens, is to correct chromatic aberrations that can occur with an AFO, especially one that works with multiple bands. In other embodiments, there may be a DOE located along the optical transmission path between the beamsplitter 62 and the first imager 58. Other embodiments may utilize two DOEs 68A, 68B with a first DOE 68A located between the beamsplitter 62 and the first imager 58 and a second DOE 68B located between each of the beamsplitter 62 and the second imager 60.

The DOE 68 is a device that uses thin micro-structure patterns to alter the phase of the light propagated through the DOE. In one example, the formation of a DOE 68 involves creating thin micro-structure patterns on a substrate. This is typically done using techniques such as photolithography or laser writing. These micro-structures can manipulate the light to almost any desired intensity profile or shape. DOE 68A or 68B can take various forms, including Fresnel lenses, Kinoforms, holographic optical elements, binary optics, and Fresnel zone plates. The specific configuration and structure depend on the application and the desired optical effect. One exemplary function of the DOE 68 is to manipulate the phase of light in a way that is not possible with traditional refractive optics. This can include beam shaping, beam splitting, and the creation of optical vortices. The parameters of the DOE 68 include the geometry of the micro-structures (which determines the phase manipulation), the material of the substrate, and the wavelength of light for which the DOE 68 is designed. The operation of a DOE 68 is based on the principle of diffraction. When light encounters the micro-structures on the DOE 68, it is diffracted, resulting in a change in the phase and direction of the light.

In one particular example, the DOE 68 may comprise different optical glass materials, such as N-FK51A, PC, and P-SF68. N-FK51A is an environmentally friendly alternative to conventional lead and arsenic-containing glass types. PC and P-SF68 are also types of optical glass. A DOE 68 could be made from these materials by creating the appropriate micro-structure patterns on their surfaces. The specific configuration, structure, function, formation, parameters, and operation would depend on the exact design of the DOE 68 and the application for which it is intended.

In other embodiments of optical assembly 40A (or other embodiments of an optical assembly detailed herein), rather than utilizing DOE 68, these other configurations of optical assembly 40A (or the other optical assemblies detailed herein) could include a metalens with a diffractive metasurface. The metalens is a type of lens that uses a flat surface, patterned with nanostructures, to focus light, rather than the curved surfaces of traditional lenses. These nanostructures are designed to create specific phase changes in the light passing through them, allowing the metalens to control the light's direction and focus it precisely. The metalens is able to manipulate light at a subwavelength scale, which is smaller than the wavelength of light itself. This is achieved through the use of metasurfaces, which are two-dimensional arrays of optical scatterers that can work in either reflection or transmission. By adjusting the geometry of these scatterers, the phase profile across the metalens surface can be tailored for an application specific purpose, such as enabling it to focus light with high precision. In one specific embodiment, the metalens can be a reconfigurable metalens. A reconfigurable metalens can switch between different focusing profiles. This is achieved using materials whose optical properties can be changed, such as optical phase change materials (O-PCMs). These materials enable the metalens to adjust its focus in response to external stimuli or computer-implemented instructions or protocols.

In one particular example, the image sensors 58, 60 are infrared (IR) sensors or IR imagers. However, different embodiments of the present disclosure would work with imagers operating in different wavebands of the electromagnetic spectrum. The imagers or image sensors 58, 60 may operate in similar wavebands or different wavebands. In the shown example, the first image sensor or first imager 58 is a short-wave infrared (SWIR) image sensor and the second image sensor or second imager 60 is a long-wave infrared (LWIR) imager sensor.

An exemplary SWIR imager (e.g., first imager 58) may operate in the 0.9-1.7 μm wavelength range. The sensors used in SWIR cameras or imagers function similarly to silica-based CCD or CMOS sensors by working as quantum detectors, converting photons into electrons. However, to detect light beyond the visible spectrum, their photon-sensitive area is made of materials such as indium gallium arsenide (InGaAs) or mercury cadmium telluride (MCT). Exemplary SWIR imagers may measure light in the SWIR region of the electromagnetic spectrum, typically defined as between 1,050 and 2,500 nm. This region may lie beyond the reach of conventional silicon-based imaging sensors. The properties of this spectrum, such as penetration of haze and smoke and its high sensitivity to moisture, make it a useful addition to small or spaced-constrained applications, such as guided munition 1 which may only have a 2.75 inch or 4 inch diameter. The SWIR spectrum requires different detectors, such as an InGaAs detector.

An exemplary LWIR imager (e.g., second imager 60) may be a high-performance, long-wave, un-cooled, IR thermal imager that disperses the 7.8-13.4 μm band into a plurality of spectral channels (e.g., 128 channels) defined by the rows of the array. LWIR sensors measure light in the long-wave infrared region of the electromagnetic spectrum. The operation of an LWIR sensor is based on the principle of interference. One exemplary LWIR imager uses an MCT detector. In another embodiment, the second imager 60 or the first imager 58 can be a multi-spectral image sensor.

In some embodiments, at least one image sensor (e.g., either first sensor 58 or second sensor 60 or both) may be a thermal imager. One exemplary thermal imager is a Boson thermal camera. The Boson thermal camera is a LWIR camera module having a 12 μm uncooled detector and may be provided in at least two resolutions (e.g., 640×512 or 320×256). The Boson thermal camera utilizes image processing and several communication interfaces. The Boson thermal camera may have an exemplary configuration frequency of 8.6 Hz and a thermal sensitivity that varies by configuration. It may have a field of view in a range from about 4° to about 95° HFOV, depending on the lens configuration. One exemplary Boson thermal camera may operate with an input power of 3.3V and power dissipation varies by configuration.

Another exemplary thermal imager is a Boson+ thermal camera. The Boson+ thermal camera is also an LWIR thermal camera module and shares many of the same mechanical, electrical, and optical interfaces as the previously discussed Boson model. The Boson+ thermal camera may feature a thermal sensitivity of less than or equal to (≤)20 mK and an upgraded automatic gain control (AGC) filter. Some exemplary Boson+ thermal cameras have one of two resolutions (e.g., 640×512 or 320×256). The Boson+ operates with low power consumption, starting at 500 mW. It also features lower video latency, enhanced tracking, seeker performance, and decision support.

The power provided by the angled faces on the surface 44, 46 of the AFO 42 is either a compromise between the two imagers 58, 60 or the power of the AFO 42 is optimized for one of the two imagers more than the other imager. In one example, the power provided by the angled or curved surfaces on the AFO 42 may be optimized for the second imager 60, particularly when the second imager 60 is an LWIR image sensor. In this instance, the photons moving through the body 48 of the AFO 42 and through the beamsplitter 62 will be corrected based on at least one curved surface of the beamsplitter 62. This allows the beams of light that move through the splitter 62 to be more focused when the power of the AFO 42 is optimized for the second imager 60.

With continued reference to FIG. 1, the shown AFO 42 is a four fold variant of the AFO. However, an eight fold is a further embodiment. When using a four fold variant of the AFO, the beamsplitter 62 has a curved surface that complements a curved portion of the frontal surface 44 near the central region 54. If an eight fold AFO 42 is utilized, which has a flat frontal surface 44, then a cubic beamsplitter may be positioned on the flat frontal surface. Other embodiments could use a cubic beamsplitter regardless of the curvature of the surfaces 44 or 46.

The optical assembly 40A may operate in conjunction with a modulation transfer function (MTF) boost function or algorithms to help boost performance. The MTF is a measure of the spatial frequency response of an imaging system or a component (e.g., the AFO). MTF is the contrast at a given spatial frequency relative to low frequencies. MTF is used in optics to describe the extent to which the system accurately reproduces (or transfers) detail from the object to the image. The MTF boost function may work by compensating for the decrease in MTF that occurs at higher or mid-spatial frequencies. This may be done by applying a boost (or gain) that increases with spatial frequency. The MTF boost function can be implemented in various ways, such as through digital signal processing techniques in the image processing pipeline. The exact implementation would depend on the specific requirements of the imaging system and the desired trade-offs between resolution, noise, and other factors. By using an MTF boost function in conjunction with the AFO 42, it can be possible to achieve higher resolution and better image quality than would be possible with the AFO alone. This can be particularly beneficial in applications where compactness and high resolution are important, such as on the guided munition.

In operation and with reference to FIG. 1A, a method 1000 for optical assembly 40A may receive electromagnetic radiation, such as light 53, through the inlet aperture 50 in AFO 42, which is shown generally at 1002. The light 53 is reflected through the body 48 of the AFO 42 toward the central region 54, which is shown generally at 1004. Near the central region 54, the beamsplitter 62 splits the light into the first portion 53A and the second portion 53B, which is shown generally at 1006. The first portion 53A of light 53 is directed toward the first imager 58 and the second portion 53B of the light 53 is directed toward the second imager 60.

The first imager 58 receives the first portion 53A of electromagnetic radiation or light 53 that has moved through the AFO 42 and has been split at the beamsplitter 62, which is optically coupled to the AFO 42. The first imager 58 generates a first image. The second imager 60 receives the second portion 53B of electromagnetic radiation that has moved through the AFO 42 and has been split (e.g., reflected) at the beamsplitter 62. The second imager 60 generates a second image. Thereafter, the optical assembly 40A may provide at least one of the first image and the second image to a target detection protocol or a guidance protocol. However, other uses of either the first image or second image are possible.

Further to this exemplary method of operation, the method for the optical assembly 40A may include receiving, at a perimeter inlet aperture 50 of the AFO 42, electromagnetic radiation; and reflecting, via at least one of the frontal surface 44 and the rear surface 46, the received electromagnetic radiation through the AFO 42 toward a central axis 56 extending centrally through the body 48 of the AFO 42. In this example, the beamsplitter 62 is positioned such that the central axis 56 intersects the beamsplitter 62. In another example, the method may include receiving, at the first imager 58, the first portion 53A of electromagnetic radiation that has moved through a concave portion of the frontal surface 44. In yet another example, the method may include receiving, at the second imager 60, the second portion 53B of electromagnetic radiation that has moved through a convex portion of the rear surface 46 after having been split by the beamsplitter 62. Some embodiments may include receiving, at one of the first imager 58 and/or the second imager 60, electromagnetic radiation that has moved through DOE 68 after having been split by the beamsplitter 62.

Another exemplary embodiment of the present disclosure related to operation of the optical assembly 40A can be embodied as a computer program product. For example, there may be a computer program product including one or more non-transitory machine-readable mediums encoded with instructions that when executed by one or more processors cause a process to detect electromagnetic radiation moving through an annular folded optic (AFO) to image a scene, wherein at least one image of the scene is to be provided to a target detection protocol or guidance protocol. The instructions of this computer program product may include receive, at the first imager 58, the first portion 53A of electromagnetic radiation that has moved through the AFO and has been split at a beamsplitter 62 coupled to one of a frontal surface and a rear surface of the AFO; generate a first image with the first imager 58; receive, at the second imager 60, the second portion 53B of electromagnetic radiation that has moved through the AFO and has been split at the beamsplitter 62; generate a second image with the second imager; and provide at least one of the first image and the second image to the target detection protocol or guidance protocol.

Stated otherwise, the first imager 58 and the second imager 60 may be in electrical communication with a guidance kit or guidance assembly, or target detection kit. The kit has a processor that is in operative communication with a computer program product installed on at least on non-transitory computer readable storage medium having instructions encoded thereon that when executed by at least one processor implements operations to evaluate or analyze the signals generated from the first imager 58 and/or the second imager 60. These signals can be processed and utilized to move elements on the guided munition 1 to thereby affect the munition 1 to move towards an intended target. In one example the processor analyzes and processes the optical signals generated from the first imager 58 and the second imager 60 to move canards or wings on a guided munition to guide the munition towards the intended target during flight.

Having thus described the first embodiment of the optical assembly 40A, it is to be understood that the optical assembly 40A may be carried by any type of platform or framework, regardless of whether it is moveable or stationary, manned or unmanned. Other embodiments of the optical assemblies detailed herein are envisioned to be a part of or located on a moveable platform. As such, prior to describing the other optical assemblies, a description of some exemplary moveable platforms is provided.

FIG. 2 illustrates a projectile, ballistic device, guided vehicle, or guided munition 1 that may be equipped with a guidance kit for guiding the illustrated guided munition 1 to a specific target. As provided herein, the illustrated guided munition 1 is a Hydra 70 rocket equipped with at least one guidance kit for guiding the illustrated guided munition 1 to a specific target, which are discussed in greater detail below. It should be understood that guided munition 1 may be any type of moveable device regardless of whether it carries a munition. For example, the guided munition 1 could also be any manned or unmanned object, such as a drone, which needs guidance in the manner discussed herein. Furthermore, the guided munition may travel through any medium. Thus, while a rocket ordinarily travels through air, it could be possible for the munition 1 to be a torpedo that travels through a water-based medium. Alternatively, the guided munition 1 could be a satellite that travels through space. Thus, some aspects of this disclosure may refer to “a device” that carries the different embodiments of optical assemblies detailed herein. When used in the broad sense, the term device would refer to any of these exemplary or other moveable objects that carry one or more of the optical assemblies detailed herein.

In the shown example, guided munition 1 can be configured to be launched from a ground-based position or platform, sea-based position or platform, atmosphere-based position or platform, outer space-based position or platform or a vehicle-based position or platform towards a desired airborne, sea-based, space-based or ground-based target. It will be understood that the platforms (not shown) discussed herein is exemplary only and any type of device is contemplated to be represented. In one exemplary embodiment, the guided munition 1 or device may be carried or launched from a platform, which may be represented as an aircraft or air vehicle (e.g., fixed-wing aircraft or rotary-wing aircraft that is manned or unmanned, such as a helicopter, jet, drone, unmanned aerial vehicle (UAV) etc.) that is capable of launching projectiles and other similar payloads from air and striking targets in air, on land, or at sea. In another exemplary embodiment, the platform described herein may be represented as hand-held launcher, a launcher fixed to a ground transporting vehicle, a launcher fixed to a naval vehicle, or other suitable launchers for launching projectiles and other similar devices from land or sea and striking targets on land or sea. In another exemplary embodiment, the platform described herein may be a ground launch vehicle that is operably engaged with a ground surface and is configured to launch surface-to-surface projectiles or missiles (or “SSM”), ground-to-ground projectiles or missiles (or “GGM”), or surface-to-air projectiles or missiles. Stated differently, the exemplary platform is capable of launching projectiles and other similar devices from land, air, outer space, or sea, and striking targets in the air, on land, at sea, or in outer space.

The guided munition 1 may include modular components that couple together to form the munition. One of the modular components may include a rocket motor or engine 10 configured to provide suitable propulsion and thrust needed for a desired military operation. The rocket motor 10 generally includes a first or front end 10A, a second or rear end 10B opposite to the first end 10A, and a longitudinal axis defined therebetween. The rocket motor 10 also generally includes a cylindrical wall 10C that extends between the first end 10A and the second end 10B along the longitudinal axis of the rocket motor 10. While not illustrated herein, suitable rocket propellants and elements may be stored inside of the cylindrical wall 10C (e.g., a chamber 10D defined inside of the cylindrical wall 10C) that generate propulsion and thrust for the rocket motor 10. The rocket motor 10 may include an aft fin member 10E operably engaged with the cylindrical wall 10C proximate to the second end 10B of the rocket motor 10. The aft fin member 10E may provide flight assistance to the guided munition 1 at the second end 10B of the rocket motor 10 as the guided munition 1 travels through the air between the initial launch at the platform and a desired target.

Guided munition 1 may include another module component that is embodied as a warhead 12 with an impact-detonating fuse 14 or another type of fuse. As best seen in FIG. 2, the combination of the warhead 12 and impact-detonating fuse 14 threadedly engage with another component of the guided munition 1 such as the forward end 22A of a guidance kit 20 (discussed below). As such, the combination of the warhead 12 and impact-detonating fuse 14 are positioned ahead of and/or forward of the rocket motor 10 and forward of the guidance kit 20. While the combination of the warhead 12 and impact-detonating fuse 14 are positioned ahead of and/or forward of the rocket motor 10 and/or the guidance kit 20, a combination of a warhead and an impact-detonating fuse may be positioned at any suitable position along a projectile described and illustrated herein. In one exemplary embodiment, a combination of a warhead and an impact-detonating fuse may be positioned between a seeker device described and illustrated herein and a guidance device such that the guidance device, the combination of the warhead and the impact-detonating fuse, and the seeker device may be a unitary, monolithic device that is assembled in a projectile. In other embodiments, the combination of the warhead 12 and impact-detonating fuse 14 are positioned ahead of and/or forward of the rocket motor 10 and rearward/aft of the guidance kit 20. In one example the guided munition has a cylindrical body with a front or nose section and a rear section wherein the motor is generally located in the rear section.

Guided munition 1 may also include a thermal battery or power source. If included, thermal battery may provide a desired amount of power to any electrical devices and/or assemblies included in guided munition 1 that are described and illustrated herein once guided munition 1 is in flight.

In the illustrated embodiment, the rocket motor 10 of the guided munition 1 may be a 4-inch rocket motor (e.g., liquid-fueled rocket motors, solid-fueled rocket motors, or other suitable rocket motors of the like). In other exemplary embodiments, any suitable rocket motor may be equipped for a projectile based on the mission and/or objective. In another particular embodiment, the guided munition may be about 2.75 inch in diameter. Yet, in other embodiments, the guided munition may have any diameter that is sufficient to meet the application specific needs of the mission.

Guided munition 1 may include a first guidance kit or apparatus (hereinafter “first guidance kit”) generally referred to as 20 that is configured to guide the guided munition 1 to a specific target. The first guidance kit 20 may include legacy hardware and guidance programs that are configured to initiate and/or deploy on-board devices to guide and/or direct the guided munition 1 to a specific target. The first guidance kit 20 is also configured to operably engage a rocket motor, such as rocket motor 10, to enable guidance capabilities to the rocket motor. As described above, the first guidance kit 20 provided with the guided munition 1 is a legacy guidance kit and/or apparatus. In one example, the legacy guidance kit described and illustrated herein may be an APKWS® laser guidance kit manufactured by BAE Systems. In another example, the legacy guidance kit described and illustrated herein may be a preexisting or legacy guidance kit that includes commercially available navigation equipment and/or instruments, including inertial navigation systems or inertial measurement units, for guiding and steering a projectile to a desired target.

With respect to first guidance kit 20, first guidance kit 20 includes a first body 22 that operably engages with the rocket motor 10 and houses the electrical components and/or device of first guidance kit 20. Body 22 may include a first end 22A, a second end 22B that is longitudinally opposite to the first end 22A and operably engages with rocket motor 10, and a wall extending longitudinally between the first end 22A and the second end 22B. The body 22 may also define a chamber that extends from the first end 22A to the second end 22B and is accessible at the first end 22A.

The first guidance kit 20 may also include a set of flaperons and wings/canards 24 that operably engages with the first body 22. In one exemplary embodiment, each wing of the set of wings 24 is moveable on the first body 22 when the guided munition 1 is launched from a platform. More particularly, the set of wings 24 is pivotable outwardly from the first body 22 and outside of the first body 22 when the guided munition 1 is launched and travels through the air (or the other mediums or spaced discussed previously). In another exemplary embodiment, each wing 24 of a set of wings discussed herein may be fixed and remain stationary with the guidance kit such that each wing of the set of wings is free from moving relative to the body of the first guidance kit. Further, while four wings 24 are depicted, a different number of wings is possible, such as eight wings, or some other number of wings that meet an application specific purpose. As used herein, wings refers to any extension from the guidance kit and not all the wings employed for steerage as some of the wings would be used only for imaging purposes.

Guided munition 1 may include a forward or nose housing 30 that operably engages the guidance kit 20 of the guided munition 1. Nose housing 30 may include a front end and a rear end that is operative coupled, either directly or indirectly, with the body 22 of the first guidance kit 20.

The first guidance kit 20 in this example has a bullet lens 251 mounted on the wing 24. The lens 251 provides an opening for the electro-optical and infrared imaging that may be used to guide the munition 1 to the target during certain phases of the flight. In this example, the lens 251 feeds an optical assembly and the light energy is then processed by an imaging sensor. As noted herein, the wing mounted lens 251 with optical assemblies can be mounted at various locations along the guided munition 1. The light energy in one example is a reflection of light energy from a target that is illuminated by a laser target designator.

The various embodiments detailed herein subsequent to FIG. 2 depict various optical assemblies that are configured to be carried by, mounted on, or installed upon the guided munition (cf., optical assembly 40B—FIG. 2A and FIGS. 3A-4B; optical assembly 40C—FIG. 2B and FIGS. 5-7). As such, guided munition 1 may generally include an optical assembly 40. Optical assembly 40 may be positioned either in front of the warhead 12 (e.g., forward of the warhead 12 toward the nose 30; cf., FIG. 2A) or behind the warhead 12 (e.g. rearward/aft of the warhead 12 toward the tail; cf., FIG. 2B). The optical assembly 40 may have some of the exemplary features detailed herein. In operation, the optical assembly 40 is configured to capture an image of a target at a desired viewing angle when munition 1 is in flight by measuring various light wavelengths emitted by one or more targets, including, but not limited to, infrared wavelengths, visible light wavelengths, and ultraviolet wavelengths. In the present disclosure, the optical assembly 40 is configured to capture an image one or more targets, such as aircrafts and air vehicles (manned or unmanned) or ground-based vehicles or structures or sea-based vehicles when guided munition 1 is in flight by the optical assembly 40 measuring various light wavelengths emitted by the targets. Then, once the image is captured, the data or captured image may be provided to a subsequent protocol for further discrimination. For example, the image may be provided to a target detection protocol (i.e., a protocol that detects a target within the scene of the image) or a guidance protocol (i.e., a protocol that guides the munition 1 toward the target based on the image scene) that is part of the guidance kit 20.

FIG. 3A-FIG. 4B depict a second embodiment of an optical assembly (i.e., optical assembly 40B) of the present disclosure that can be utilized on guided munition 1 or may be utilized in a different device. When optical assembly 40B is carried by the guided munition 1, the munition body is powered by a motor or engine 10 to propel the munition body through a medium in response to being fired or launched. The warhead 12 is coupled to the munition body. The optical assembly 40B can include an AFO 142 on the guided munition 1 positioned forwardly of the warhead 12.

The AFO 142 may include a frontal surface 144 and a rear surface 146, and a body 148 of the AFO 142 extending between the frontal surface 144 and the rear surface 146. AFO 142 has a thickness of the body 148 measured from the frontal surface 144 to the rear surface 146. A central axis 156 extends fore-to-aft centrally through the body 148 of the AFO 142 from the frontal surface 144 to the rear surface 146.

AFO 142 defines at least one slot that is formed through the thickness of the body 148 of the AFO 142. There may be a first slot 170A extending entirely through the thickness of the body 148 of the AFO 142. The first slot 170A has a proximal end 172A and a distal end 174A defining a length 176A of the first slot 170A. The length 176A of the first slot 170A is coaxial to a first radius 178A of the AFO 142 originating at the central axis 156. The proximal end 172A of first slot 170A is radially distal from the central region 154 and/or radially distal from the central axis 156. The central region 154 of the AFO 142 is unaltered by the first slot 170A (or any of the other slots discussed herein).

A second slot 170B may extend entirely through the thickness of the body 148 of the AFO 142. The second slot 170B has a proximal end 172B and a distal end 174B defining a length 176B of the second slot 170B. The length 176B of the second slot 170B is coaxial to a second radius 178B of the AFO 142 originating at the central axis 156. The second radius 178B is approximately 90 degrees from the first radius 178A.

A third slot 170C may extend entirely through the thickness of the body 148 of the AFO 142. The third slot 170C has a proximal end 172C and a distal end 174C defining a length 176C of the third slot 170C. The length 176C of the third slot 170C is coaxial to a third radius 178C of the AFO 142 originating at the central axis 156. The third radius 178C is approximately 90 degrees from the second radius 178B, and the third radius 178C is approximately 180 degrees from the first radius 178A.

A fourth slot 170D may extend entirely through the thickness of the body 148 of the AFO 142. The fourth slot 170D has a proximal end 172D and a distal end 174D defining a length 176D of the fourth slot. The length 176D of the fourth slot 170D is coaxial to a fourth radius 178D of the AFO 142 originating at the central axis 156. The fourth radius 178D is approximately 90 degrees from the first radius 178A and the third radius 178C, and the fourth radius 178D is approximately 180 degrees from the second radius 178B.

The AFO 142 can have any number of slots to meet the application specific needs of the optical assembly. For example, while the shown embodiment is depicted with four slots 170, any number of slots may be used. For example, the total number of slots in the AFO can be one, two, three, or five or more.

When viewed from the frontal surface, at least one of the slots has a generally rectangular profile. However, it is possible that more than one or all of the slots a generally rectangular profile. For example, the first slot 170A may have a first side edge 180A of the first slot 170A and a second side edge 182A of the first slot 170A. The first side edge 180A and the second side edge 182A are parallel to each other on opposite sides of the first radius 178A. A similar configuration applies to the other slots and their edges 180B-180D and 182B-180D relative to radii 178B-178D, respectively. It should be appreciated that this configuration does not result in a slot having a tapered or wedge-shaped configuration (similar to the shape of a pizza slice). Having a generally rectangular profile assists to accommodate components that need to be positioned with or extend through each slot. One example is for a wedge-shaped slot. For example, FIG. 3D depicts a different embodiment of an AFO 142-2 in which the slots 170A2, 170B2, 170C2, and 170D2 are shown with a wedge-shaped configuration.

FIG. 3B and FIG. 3C depict that optical assembly 40B may operate in conjunction with other components on guided munition 1 or another suitable platform. For example, at least one sensor 184 may be positioned forwardly of the frontal surface 144 of the AFO 142. The sensor 184 may be any type of sensor that is capable of capturing signals and generating data that is to be transmitted to another component on the guided munition 1. Given the location of the sensor 184 being forward of the frontal surface 144 of the AFO 142, the signals must be transmitted rearward to the processing hardware, which is located rearward of the AFO 142. As such, a signal transmission component 186 is connected to the sensor 184 and extends through at least one of the slots, such as the first slot 170A, to transmits a sensor signal to a receiving device (such as a processor) that is positioned rearward of the rear surface 146 of the AFO 142.

In one example, the sensor 184 may be a phased array antenna. A phased array antenna is a type of antenna that uses multiple individual radiating elements, or antennas, to create a directional beam of radio waves. Unlike traditional antennas that have a fixed direction of radiation, phased array antennas can electronically steer their beams without physically moving the entire antenna structure. This electronic beam steering is achieved by adjusting the phase of the signals fed to each individual element in the array. The elements are distributed in a specific pattern to achieve the desired beamforming characteristics. Each element in the array may be equipped with a phase shifter. The phase shifter controls the phase of the signal applied to the corresponding element. By adjusting the phase of the signals across the array, the antenna can steer its beam in different directions. The signals from the individual elements are combined using a beamforming network. This network ensures that the signals add constructively in the desired direction, reinforcing the beam in that specific direction. Phased array antennas require a control unit, which may be located rearward from the rear surface 146 of the AFO 142, that manages the phase shifters and coordinates the beamforming process. This unit may be controlled through an automated system, allowing for dynamic and rapid adjustments to the antenna's beam direction. The phased array antenna may be electronically steered. This capability enables rapid and precise adjustments, making it suitable for applications such as radar systems, communication systems, and satellite communication. Phased array antennas can rapidly switch the direction of their beams, making them well-suited for applications that require quick changes in target tracking or communication with multiple directions. Some phased array antennas support adaptive beamforming, allowing them to dynamically adapt to changes in the environment or interference sources, optimizing performance in real-time.

Although the sensor 184 has be detailed as phased array antenna, other types of antennas are possible. For example, the sensor could also be an Adaptive Array Antenna (AAA) or planar array. In other examples, the sensor does not need to be an antenna. For example, sensor 184 can any type of sensor that is configured to sense or gather data pertaining to the surrounding environment or operation of the munition 1, assembly 40B (or other optical assembly detailed herein), or the overall system. Some exemplary other sensors capable of being electronically coupled with the optical assembly 40A and positioned forward of the frontal surface 144 of AFO 142 may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of air/fluid passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding moisture levels.

Regardless of the type of sensor, the transmission component 186 is a component that transmits the sensed signal data through the AFO 142 by extending through or being disposed within one of slots 170A-170D. Some examples of components that could be the signal transmission component 186 that can transmit a signal between two devices include cables/wires, connectors, transceivers, repeaters, modems or modulators/demodulators, switches and/or routers, amplifiers, encoders/decoders (Codecs), multiplexers/demultiplexers (MUX/DEMUX), or serializers-deserializers (SERDES), or the like. The shown example embodies the transmission component 186 in the first slot 170A and the fourth slot 170D as a data connector, and the transmission component in the second slot 170B and the third slot 170C is a power connector 187.

There may be other components located with the respect slots that extend through the body 148 of AFO 142. For example, when the sensor 184 is embodied as a phased array antenna, there may be one or more flexure mounts 188 passing through the slots. A flexure is mechanical elements used in designs to allow an object to bend or flex in a controlled manner. In the context of phased array antennas, flexures 188 may be used to adjust the physical shape of the antenna array. Flexures are also used as semi-kinematic mounts so the antenna stays on target as temperature changes. This may be beneficial when the antenna needs to maintain a specific shape or orientation to function optimally. In one example, the flexures 188 may be fabricated from titanium.

Still further, there may be at least one semiconductor device 190 located in or extend through one or more of the slots 170A-170D. In one embodiment, the semiconductor located within one of the slots, some of the slots, or all of the slots 170A-170D is an avalanche photodiode (APD). In one exemplary embodiment, within each APD, there may be eight elements such as what is taught in U.S. Pat. Nos. 8,390,802 and 11,168,959. An APD is a type of semiconductor photodetector that operates in the photodetection mode and utilizes the avalanche effect for signal amplification. It is commonly used in applications where high sensitivity and low noise are required. APDs are typically constructed from semiconductor materials, such as silicon or III-V compounds like gallium arsenide (GaAs) or indium gallium arsenide (InGaAs). The choice of material depends on the desired wavelength sensitivity. Similar to other photodetectors, an APD converts incident photons into electron-hole pairs when exposed to light. This is known as the photodetection process. In a standard photodiode, the generated electron-hole pairs contribute directly to the photocurrent. In an APD, the generated carriers undergo multiplication through impact ionization. When carriers gain enough energy, they collide with other atoms in the crystal lattice, creating additional electron-hole pairs. This multiplication process is called avalanche multiplication, and it leads to an exponential increase in the number of charge carriers. The avalanche multiplication results in gain, which is the ratio of the number of output charge carriers to the number of initial carriers generated by incident photons. This gain improves the signal-to-noise ratio of the detected signal, making APDs more sensitive to low-light conditions compared to conventional photodiodes. APDs require a reverse bias voltage to operate. This bias voltage creates an electric field within the semiconductor material, allowing the generated carriers to gain sufficient energy for the avalanche multiplication process. To prevent excessive multiplication and avoid the breakdown of the APD, a quenching circuit may be used. This circuit limits the duration of the avalanche effect, ensuring the APD operates in a controlled manner. The APDs may be located anywhere within each respective slot 170A-170D. In the shown embodiment the APD arrays are located at the radially distal or near the radially outermost portion of each slot 170A-170D so as to provide the largest FOV or FOR possible. As such, the each respective APD array is located near or along a similar radius of curvature of the inlet of the AFO. Additionally, the APDs should be centered in the slot to reduce potential of vignetting.

FIG. 4A-FIG. 4B depict that optical assembly 40B may additionally include an imager sensor 158 positioned and its constituent components and connectors rearward of the rear surface 146 of the AFO 142. In one embodiment, the imager sensor or imager 158 may be a thermal camera. Some exemplary components of the thermal camera that may be located rearward of the AFO 142 can include the IR sensor, one or more amplifiers, and/or one or more signal processors. The imager 158 may be a Boson camera, similar to that which was previously described.

In operation, optical assembly 40B may receive electromagnetic radiation, such as light, through the inlet aperture 150 in AFO 142, which may be on the guided munition 1. However, optical assembly 40B may operate separate from guided munition 1 and be on a different platform. The light is reflected through the body 148 of the AFO 142, in the portion of body 148 between the slots 170A-170D, toward the central region 154. The imager 158 receives the electromagnetic radiation that has moved through the AFO 142. In this operation, the AFO 142 is positioned forwardly from the warhead 12 on the guided munition 1. The imager 158 generates an image. Then, the image is provided to one of (i) a target detection protocol that detects a target in the image or (ii) a guidance protocol that guides the guided munition toward the target in the image.

The optical assembly 40B works in conjunction with sensor 184 that is located forward of AFO 142. The sensor 184 may sense a signal and generate data in response to sensing the data. That signal is physically transmitted through the AFO 142 via a signal transmission component 186 that extends through or is located within of the slots 170A-170D. A processing component or processor can be connected to the signal transmission component 186 to process the signal received by the sensor 184.

In one example, the incoming light 53 received by the semiconductor device 190 may convert the light energy into electrical energy that is routed through the signal transmission path 186 to the imaging sensor 184. In this manner, the assembly processes both the incoming light energy via the AFO 142 and the semiconductor device 190.

Regarding the method of manufacture, the AFO 142 will likely be first formed as a complete unit. Thereafter, the three or more slots 170A-170D may then be cut into the body 148 of the AFO 142 to extend entirely therethrough from the frontal surface 144 to the rear surface 146. The inner proximal end 172A-172D of each respective slot 170A-170D terminates distally from the central axis 156 leaving a center region 154 that maintains the integrity and optical stability of the modified AFO 142. This also maintains optical precision near the center region 154 of the AFO 142 so that the beams of light or wavebands moving through the body 148 of the AFO 142 can be detected by the imager 158 that is in communication therewith. The cut surfaces of the slots 170A-170D may be coated with black paint like ACMI #2613.

Another exemplary embodiment of the present disclosure related to operation of the optical assembly 40B can be embodied as a computer program product. For example, there may be a computer program product including one or more non-transitory machine-readable mediums encoded with instructions that when executed by one or more processors cause a process to detect electromagnetic radiation moving through the AFO 142 to image a scene, wherein at least one image of the scene is to be provided to a target detection protocol or guidance protocol, the instructions comprising: receive, at the imager 158, electromagnetic radiation that has moved through the AFO, wherein the AFO is positioned forwardly from the warhead 12 on the guided munition 1; generate an image with the imager 158; and provide the image to one of (i) a target detection protocol that detects a target in the image or (ii) a guidance protocol that guides the guided munition toward the target in the image. The instructions may further include: sense a signal with the sensor 184 positioned forwardly of the AFO 142; and transmit the signal through the signal transmission component 186 that extends through one of the slots 170A-170D formed through a thickness of the body of the AFO 142.

The configuration of optical assembly 40B permits more sensors, hardware, and/or other technology to be placed on the munition 1 that necessarily has physical space constraints due to the size of the munition 1. The usage of an AFO 142 has the advantage of putting another device in front of the frontal surface 144 of the AFO 142, such as another electro-optic device, a radar device, a LIDAR device, or any other type of sensor hardware that will provide more details of the surrounding environment or the operation of the munition. Similar to the other optical assemblies, optical assembly 40B can work in conjunction with an MTF boost protocol or algorithm to improve image quality lost due to the obscuration aspect of an AFO.

Although the depicted optical assembly 40B is shown with four slots, it is possible to have fewer or more slots. For example, another embodiment can utilize eight slots that results in eight inlet apertures around the perimeter of the AFO.

FIG. 5-FIG. 8 depict another exemplary optical assembly (i.e., optical assembly 40C) of the present disclosure that can be utilized on guided munition 1 or may be utilized in a different device. When optical assembly 40C is carried by the guided munition 1, the munition body powered by a motor or engine 10 to propel the munition body through a medium in response to being fired or launched. The warhead 12 is coupled to the munition body. The optical assembly 40C can include an AFO 242 on the guided munition 1 positioned, at least partially, on a wing 24 of the munition. In this example, the AFO 242 is located rearward of warhead 12.

FIG. 5 depicts the AFO 242 as a transversely segmented AFO. The AFO 242 has a body 248 defining a frontal surface 244 and a rear surface 246 of the AFO 242. Similar to the other AFOs, at least one of the frontal surface 244 and the rear surface 246 internally reflects electromagnetic radiation through the body 248, wherein the electromagnetic radiation has entered through an inlet aperture 250 that is coextensive with the perimeter of the AFO 242. A central axis 256 extends centrally through the body 248 from the frontal surface 244 to the rear surface 246.

AFO 242 includes a first portion 292A, a second portion 292B, a third portion 292C, and a fourth portion 292D. The portions 292A-292D may be linearly elongated and formed by cutting away regions 293A, 293B, 293C, and 292D away from the body 248, leaving the portions 292A-292D that extend radially outward from the central region 254. In the shown embodiment, each of the portions 292A-292D extend radially outward from the central axis defining generally rectangular portions the body. The portions 292A-292D have a smaller surface area than the area of the cutaway regions 293A-293D. Alternatively, the portions 292A-292D have a smaller volume than the volume of the cutaway regions 293A-293D. Each portion 292A-292D may include an inlet aperture 250A-250D, respectively, at the radial end thereof.

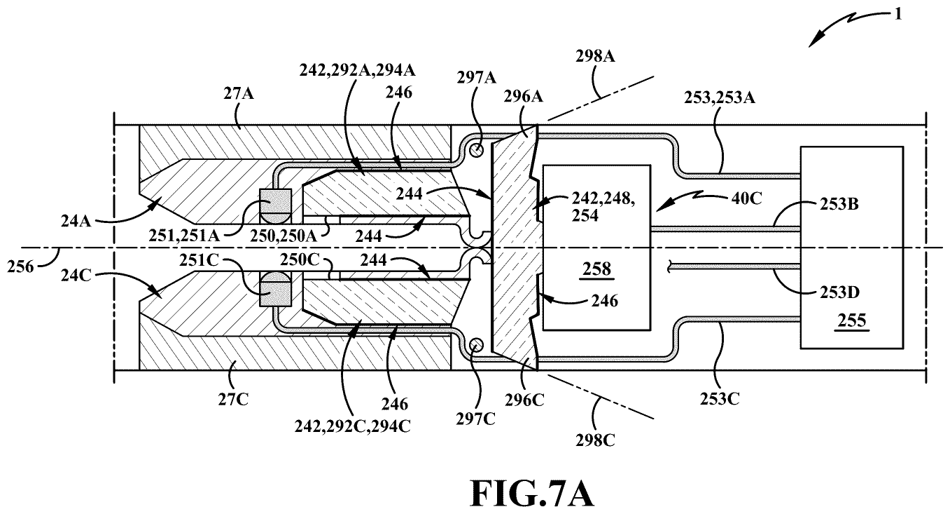

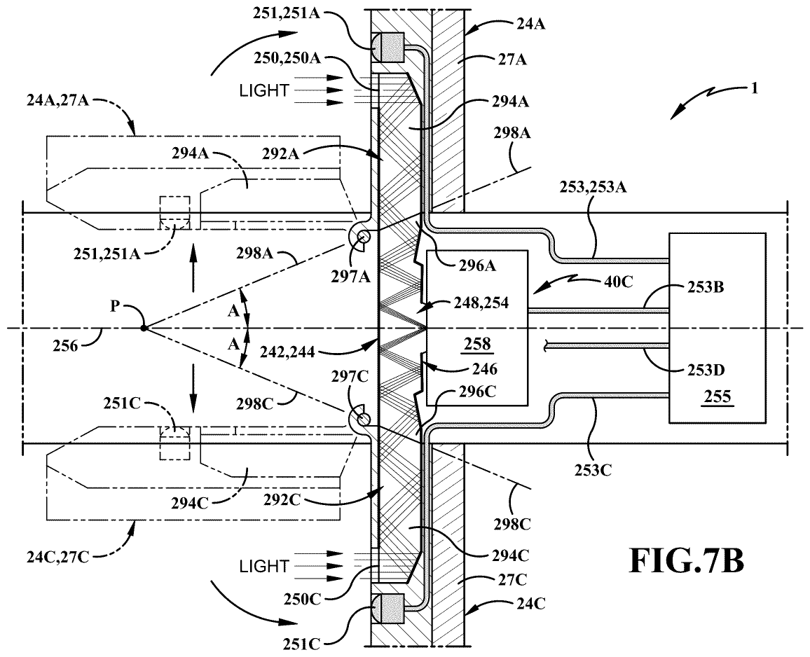

Each portion 292A-292D may be composed of two or more segments that may be moveable relative to each other between a collapsed position and a deployed position, wherein the two or more segments interface together when deployed. There is an interface plane, wherein the interface lies along the interface plane. As best seen in FIG. 7A-FIG. 7B, the interface plane intersects the central axis 256 at a point “P”, wherein the point “P” at which the interface plane intersects the central axis is located outside the body 248 of the AFO 242. There may be an angle “A” that is in a range from about 10° to about 80° defined between one of the interface planes 298A-298D and the central axis 256 at the point “P” at which the interface plane intersects the central axis 256 outside the body of the AFO 242.

For example, first portion 292A of the AFO 242 comprises the first segment 294A and the second segment 296A. The first segment 294A is radially distal from the second segment 296A of the first portion 292A relative to the central axis 256 of the AFO 242. The first segment 294A and the second segment 296A are moveable relative to each other between a collapsed position and a deployed position. A first interface exists at first interface plane 298A between the first segment 294A and the second segment 296A of the first portion 292A when the first segment 294A and the second segment 296A of the first portion 292A are in the deployed position. Electromagnetic radiation that is received at the inlet 250A on the first segment 296A of the first portion 292A moves through the first interface at first interface plane 298A toward the central region 254 where it may be detected by an imager 258.

Second portion 292B of the AFO 242 comprises the first segment 294B and the second segment 296B. The first segment 294B is radially distal from the second segment 296B of the second portion 292B relative to the central axis 256 of the AFO 242. The first segment 294B and the second segment 296B are moveable relative to each other between a collapsed position and a deployed position. A second interface exists at the second interface plane 298B between the first segment 294B and the second segment 296B of the second portion 292B when the first segment 294B and the second segment 296B of the second portion 292B are in the deployed position. Electromagnetic radiation that is received at the inlet 250B on the first segment 296B of the second portion 292B moves through the second interface at second interface plane 298B toward the central region 254 where it may be detected by an imager.

Third portion 292C of the AFO 242 comprises the first segment 294C and the second segment 296C. The first segment 294C is radially distal from the second segment 296C of the third portion 292C relative to the central axis 256 of the AFO 242. The first segment 294C and the second segment 296C are moveable relative to each other between a collapsed position and a deployed position. A third interface exists at the third interface plane 298C between the first segment 294C and the second segment 296C of the third portion 292C when the first segment 294C and the second segment 296C of the third portion 292C are in the deployed position. Electromagnetic radiation that is received at the inlet 250C on the first segment 296C of the third portion 292C moves through the third interface at the third interface plane 298C toward the central region 254 where it may be detected by an imager.

Fourth portion 292D of the AFO 242 comprises the first segment 294D and the second segment 296D. The first segment 294D is radially distal from the second segment 296D of the fourth portion 292D relative to the central axis 256 of the AFO 242. The first segment 294D and the second segment 296D are moveable relative to each other between a collapsed position and a deployed position. A fourth interface exists at the fourth interface plane 298D between the first segment 294D and the second segment 296D of the fourth portion 292D when the first segment 294D and the second segment 296D of the fourth portion 292D are in the deployed position. Electromagnetic radiation that is received at the inlet 250D on the first segment 296D of the fourth portion 292D moves through the fourth interface at the fourth interface plane 298D toward the central region 254 where it may be detected by an imager.

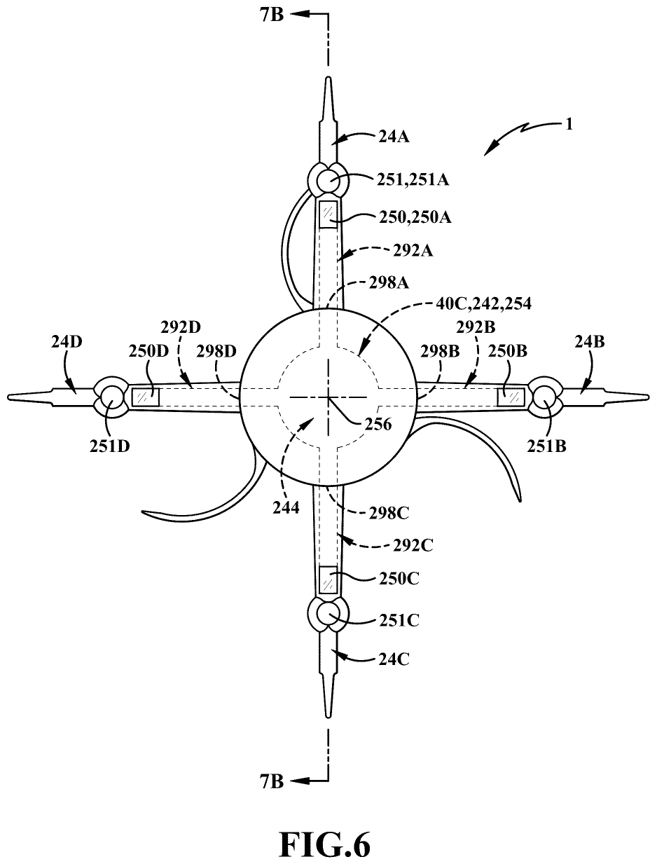

FIG. 6 depicts a front end elevation view of the guided munition 1 in which the munition body is powered by the motor or engine 10 to propel the munition body through a medium in response to being fired or launched. Munition 1 carries warhead 12, and the AFO 242 may be positioned rearward of the warhead. However, it is possible to position AFO 242 forwardly of warhead 12 to meet application specific needs of munition 1.

In one embodiment, there is a first deployable wing 24A, which may be pivotably connected to the munition body. In this embodiment, the AFO 242 is provided on the munition 1, wherein at least the first portion 292A of the AFO 242 is on the first deployable wing 24A. This embodiment may further have a second deployable wing 24B pivotably connected to the munition body and the second portion 292B of the AFO 242 is on the second deployable wing 24B. There may be a third deployable wing 24C pivotably connected to the munition body and third portion 292C of the AFO 242 is on the third deployable wing 24C. There may also be a fourth deployable wing 24D pivotably connected to the munition body and the fourth portion 292D of the AFO 242 is on the fourth deployable wing 24D.

At least one of the wings 24A-24D may further include a lens 251 for a seeker such as a distributed aperture semi-active laser seeker. In the shown embodiment, there is at least one lens 251A-251D for a seeker located on each of the wings 24A-24D located distally from the respective first segments 294A-294D of the AFO 242. One exemplary lens for a seeker is taught in U.S. Pat. No. 8,712,201, which is incorporated herein by reference. Each lens 251A-251D may be connected, via optical fibers 253A-253D, to an optical sensor, such as an APD, that is eventually electronically connected to a processor or microprocessor 255, which may be in electrical communication with the imager 258. The electrical connection may have any intervening components to permit the operation and communication thereof, such as an analog section that is converted with an Analog-to-Digital Converter (ADC).

FIG. 7A-FIG. 7B depict that the AFO 242 may be transversely sliced or cut, along the respective interface planes 298A-298D, so that first segments 294A-294D can pivot about at least one pivot axis, respectively. This allows the first segments 294A-294D of the respective portions 292A-292D to be installed on the deployable wings 24A-24D of the guided munition 1. Each of the wings 24A-24D may have at least one flaperons or flap 27A-27D, respectively. The AFO 242 is moved between a collapsed position and a deployed position in response to the deployment of the wings upon launching the guided munition 1.

FIG. 7A depicts the interface plane 298A upon which the first portion 292A of the AFO 242 is sliced or otherwise cut to permit the pivoting action of the first segment 294A about pivot axis 297A. Similarly depicted is the interface plane 298C upon which the third portion 292C of the AFO 242 is sliced or otherwise cut to permit the pivoting action of the first segment 294C about pivot axis 297C.

AFO 242 in this embodiment is shown as an eight-fold AFO. The greater fold amount is necessary because it is the fold count that will fit in a wing. Particularly, four-fold AFOs are typically too thick and their aspect ratio is too low to extend far enough out into the wing without making the wing too wide/deep. Additionally, the eight-fold AFO is advantageous because the interface plane 298A which the first portion 292A of AFO 242 is sliced or cut so that it may collapse or otherwise move between the collapsed position and the deployed position should extend through the body 248 of the AFO 242 from the frontal surface 244 to the rear surface 246 at a location that does not reflect the wavebands of light moving though the AFO 242. Stated otherwise, the first portion 292A of AFO 242 is cut at a location where the wavebands do not reflect off the internal surfaces of the AFO. A gap or spatial distance between reflection points is established on the frontal surface 244 of the AFO 242. Similarly, a gap or spatial distance is defined between reflection points on the rear surface 246 of the AFO 242. The slice or separation in the AFO along the interface plane 298A extends from the gap on the frontal surface 244 through the body of the AFO to the gap in the rear surface. This is advantageous as no wavebands of light or rays contact these points. This should eliminate the introduction of diffraction as the wavebands pass through the interface along the interface plane 298A between the outer portion of the AFO and the inner portion of the AFO.

FIG. 7A depicts that the wings 24 of the guided munition 1 may be forwardly stowed in the collapsed position. However, other embodiments can utilize wings that deploy forward from a rearwardly stowed position. By stowing the wings in a forward stowed position the guided munition 1 is able to utilize drag forced of the air as the guided munition moves through the medium to help deploy the wings rearward. The rearward movement of the wings to the deployed position occurs by allowing the wings to pivot about the pivot axes 297A-297D.

FIG. 7B depicts that when the wing is pivoted to the deployed position the first segment 294A-294D of each respective portion 292A-292D interface with each respective second segment 296A-296D at their interface plane 298A-298D. The wing may be provided with a wing slot seal, such as what is taught in U.S. Pat. No. 8,898,908.

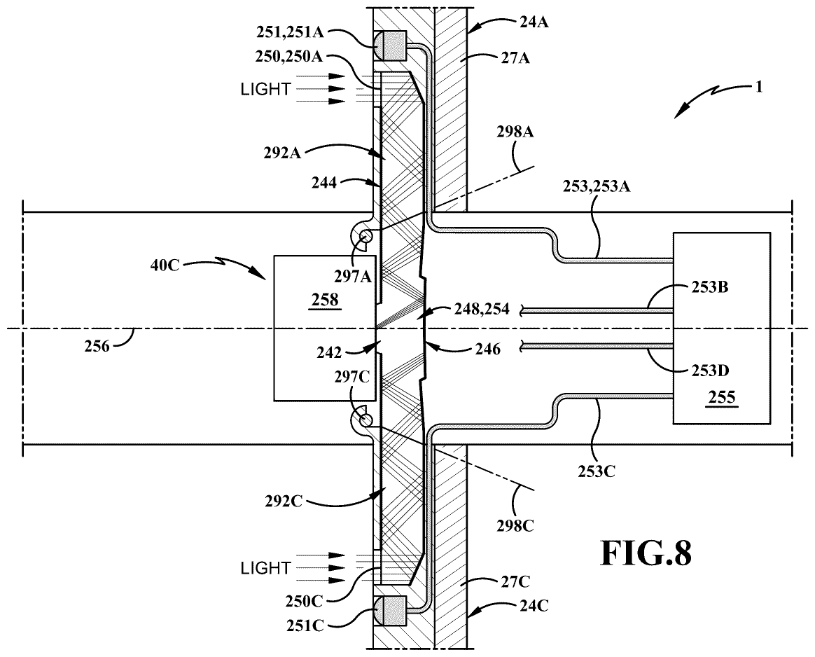

FIG. 8 depicts another embodiment which, instead of an eight-fold AFO, uses a seven-fold AFO. If a seven-fold AFO optic is utilized, then the image sensor 258 would be located forward of the frontal surface 244 of the seven-fold AFO. A seven-fold AFO may be advantageous when space constraints within the body of the guided munition 1 are limited. Namely, as shown herein, there is typically space available for positioning devices forwardly of the AFO and thus a seven-fold AFO would enable the image sensor 258 to be located forwardly of the frontal surface 244 of the seven-fold AFO.

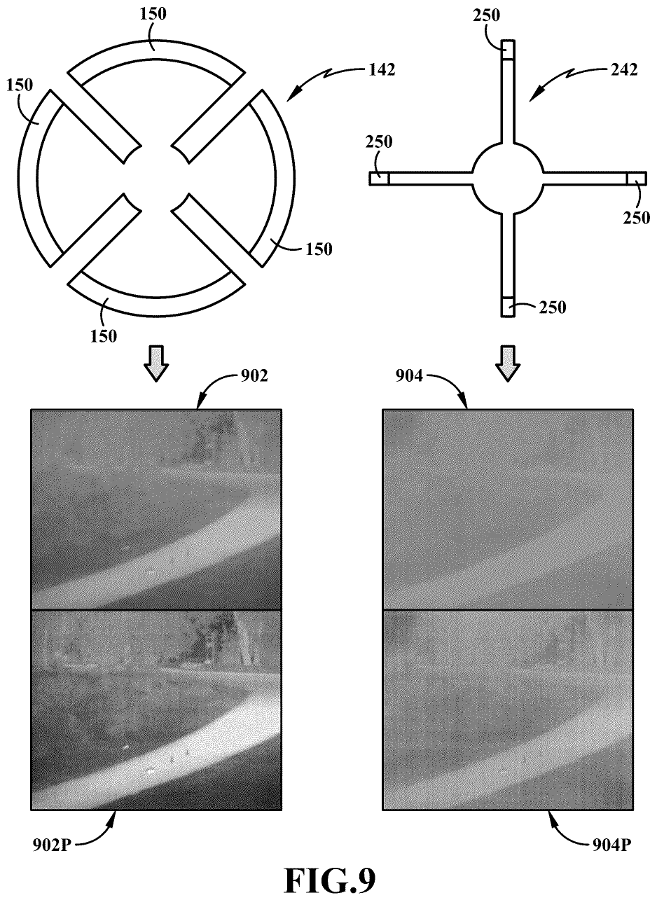

FIG. 9 depicts exemplary images obtained from AFO 142 and AFO 242, respectively. The scenery in the exemplary images were obtained on a driveway with a model car being placed atop a heating element to create a temperature differential. Image 902 was acquired using AFO 142. Then, an image processing technique applied the MTF boost function to result in processed image 902P, wherein the suffix “P” refers to “processed.” It can be seen that processed image 902P resulting from the use of AFO 142 can identify the heating element placed beneath the model car, which is visible in the black-and-white photographs as the white spot beneath the model car. Similarly, Image 904 was acquired using AFO 242. Then, an image processing technique applied the MTF boost function to result in processed image 904P. It can be seen that processed image 904P resulting from the use of AFO 242 can identify the heating element placed beneath the model car, which is visible in the black-and-white photographs as the white spot beneath the model car.

Having thus described some exemplary configurations of the present disclosure, reference is now made to some other exemplary and non-limiting features of these embodiments.

If one or more sensors, such as sensor 184 or another sensor, are utilized to gather data relating to the munition 1, another device, assembly, or system of munition 1 or signal data emanating from a target remote from munition 1, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements.

A sensor model may be employed, once trained, in the munition 1 or one of the optical assemblies 40A-40C. In one embodiment, the munition 1 or one of the optical assemblies 40A-40C can be used to teach a sensor model to predict sensor data for a specific scenario. Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the munition 1 or one of the optical assemblies 40A-40C can use the sensors to acquire a representation of the real-world environment (e.g., a physical environment or of a target remote from the munition 1) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions (e.g., depth maps), classification data identifying objects or targets (e.g., friendly or adversarial) in the scene or surrounding environment, properties or classification data. Generally, the sensor model learns to predict sensor data from a representation of the scene, environment or operation of the munition 1 or one of the optical assemblies 40A-40C.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a CNN that accepts and evaluates an input image and may include multiple input channels, which may be used to accept and evaluate multiple input images and/or input vectors.

In one embodiment, training data for the sensor model may be generated using real-world (e.g., physical environment) data. To collect real-world training data, the munition 1 or one of the optical assemblies 40A-40C may collect sensor data by fusing sensors as a munition or other platform traverses a real-world environment. The sensors of the munition 1 or one of the optical assemblies 40A-40C may include, for example, one or more global navigation satellite systems sensors (e.g., Global Positioning System sensors (GPS)), RADAR sensors, ultrasonic sensors, LIDAR sensors, inertial measurement unit (IMU) sensors (e.g., accelerometer(s), gyroscope(s), magnetic compass(es), magnetometer(s), etc.), ego-motion sensors, microphones, stereo cameras, wide-view cameras (e.g., fisheye cameras), infrared cameras, surround cameras (e.g., 360 degree cameras), long-range and/or mid-range cameras, speed sensors (e.g., for measuring the speed of the munition), vibration sensors, steering sensors, brake sensors, and/or other sensor types, such as the others previously discussed.

In another embodiment, training data for the sensor model is generated based on simulated or virtual environments. The training data may then be used to train the sensor model for use in real-world autonomous applications, e.g., to control the operation of the munition 1 or one of the optical assemblies 40A-40C. The training data may be derived to fit the shape of the input and output data for the sensor model, which may depend on the architecture of the sensor model. For example, sensor data may be used to encode an input scene, input parameters, and/or ground truth sensor data using different data structures and/or channels (e.g., concatenated vectors, matrices, tensors, images, etc.).

The munition 1 or one of the optical assemblies 40A-40C may include hardware, software and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the munition 1 or one of the optical assemblies 40A-40C. In one example, the autonomous hardware, software, and/or firmware can be installed in and used to control the munition 1 or one of the optical assemblies 40A-40C through the environment based on the sensor data, one or more machine learning models (e.g., neural networks), and the like. A training system may use the training data to train the sensor model to predict virtual sensor data for a given scene, environment, or operation of a component.

The autonomous hardware, software, and/or firmware being executed may for munition 1 or one of the optical assemblies 40A-40C enable the munition 1 to operate as a “fire and forget” or “fire and soon forget” munition.

The munition 1 or one of the optical assemblies 40A-40C may include wireless communication logic coupled to additional sensors on the munition 1 or one of the optical assemblies 40A-40C. The additional sensors gather data and provide the data to the wireless communication logic. Then, the wireless communication logic may transmit the data gathered from the sensors to a remote device, if desired. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the munition 1 or one of the optical assemblies 40A-40C of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware, or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey the relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the methods or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An optical assembly comprising:
an annular folded optic (AFO) that has a frontal surface and a rear surface, and a body of the AFO extending between the frontal surface and the rear surface;
a first imager in optical communication with the frontal surface; and
a second imager in optical communication with rear surface;
a beamsplitter coupled to one of the frontal surface and the rear surface, wherein the beamsplitter splits electromagnetic radiation moving through the body of the AFO into a first portion that is directed toward the first imager and a second portion that is directed toward the second imager.

2. The optical assembly of claim 1, wherein a portion of the frontal surface is concave, wherein the beamsplitter is optically coupled to the concave portion of the frontal surface.

3. The optical assembly of claim 1, wherein a portion of the rear surface is convex, wherein the beamsplitter is optically coupled to the convex portion of the rear surface.

4. The optical assembly of claim 1, further comprising:
a central axis extending centrally through the body of the AFO from the frontal surface to the rear surface;
wherein the beamsplitter is positioned such that the central axis intersects the beamsplitter.

5. The optical assembly of claim 4, wherein the first imager is positioned such that the central axis intersects the first imager.

6. The optical assembly of claim 4, wherein the second imager is positioned such that the central axis intersects the second imager.

7. The optical assembly of claim 1, further comprising:
at least one diffractive optical element (DOE) located between the beamsplitter and one of the first imager and the second imager.

8. The optical assembly of claim 1, further comprising:
a first DOE located between the beamsplitter and the first imager; and
a second DOE located between the beamsplitter and the second imager.

9. The optical assembly of claim 1, wherein the first imager is a short-wave infrared (SWIR) image sensor and the second imager is a long-wave infrared (LWIR) imager sensor.

10. The optical assembly of claim 1, wherein the AFO is a four-fold AFO.

11. An optical assembly comprising:
an annular folded optic (AFO) on a device, wherein the AFO has a frontal surface and a rear surface, and a body of the AFO extending between the frontal surface and the rear surface;
a first imager in optical communication with the frontal surface;
a second imager in optical communication with rear surface;
a beamsplitter optically coupled to one of the frontal surface and the rear surface, wherein the beamsplitter splits electromagnetic radiation moving through the body of the AFO into a first portion directed toward the first imager and a second portion directed toward the second imager; and
a guidance kit, wherein the AFO is in operative communication with the guidance kit such that electromagnetic radiation that has passed through the AFO is detected by at least one of the first imager and the second imager that generates at least one signal that is provided to the guidance kit and the signal is utilized to guide the device toward a target.

12. A method comprising:
receiving electromagnetic radiation through an inlet aperture of an annular folded optic (AFO), wherein the inlet aperture is located around at least a portion of the periphery of the AFO;
reflecting the electromagnetic radiation between a frontal surface and a rear surface of the AFO, wherein reflected electromagnetic radiation is directed toward a center of the AFO; and
splitting, via a beamsplitter, the electromagnetic radiation into a first portion and a second portion, wherein the beamsplitter is in optical communication with at least one of the frontal surface and the rear surface of the AFO.

13. The method of claim 12, further comprising:
receiving, at a first imager, the first portion of electromagnetic radiation that has moved through the AFO and has been split at the beamsplitter;
generating a first image with the first imager

14. The method of claim 13, further comprising:
receiving, at the first imager, the first portion of electromagnetic radiation that has moved through a concave portion of the frontal surface.

15. The method of claim 13, further comprising:
receiving, at a second imager, the second portion of electromagnetic radiation that has moved through the AFO and has been split at the beamsplitter; and
generating a second image with the second imager.

16. The method of claim 15, further comprising:
receiving, at the second imager, electromagnetic radiation that has moved through a convex portion of the rear surface after having been split by the beamsplitter.

17. The method of claim 15, further comprising:
providing at least one of the first image and the second image to a target detection protocol or guidance protocol.

18. The method of claim 15, further comprising:
receiving, at one of the first imager and the second imager, electromagnetic radiation that has moved through a diffractive optical element (DOE) after having been split by the beamsplitter.

19. The method of claim 11, wherein the beamsplitter intersects a central axis of the of the AFO.
